(19) United States
(12) Patent Application Publication
(10) Pub. No.: US 2026/0025764 A1
(43) Pub. Date: Jan. 22, 2026

(54) RETRANSMISSIONS IN SMALL DATA TRANSMISSION SESSIONS WITH A LOW-POWER WAKE-UP SIGNAL

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Tao LUO, San Diego, CA (US); Igor GUTMAN, Hod HaSharon (IL); Hemant SAGGAR, San Diego, CA (US); Kazuki TAKEDA, Minato-ku (JP)

(21) Appl. No.: 19/237,805

(22) Filed: Jun. 13, 2025

Related U.S. Application Data
(60) Provisional application No. 63/672,401, filed on Jul. 17, 2024.

(51) Int. Cl. H04W 52/02; H04L 5/00; H04W 76/38

(52) U.S. Cl. CPC H04W 52/0235; H04L 5/0055; H04W 76/38

(57) ABSTRACT

Various aspects of the present disclosure generally relate to wireless communication. In some aspects, a user equipment (UE) may transmit, for at least one data packet, a request for a small data transmission (SDT) session with a network. The UE may receive a low-power wake-up signal (LP-WUS) from the network. The UE may receive, in the SDT session, control information from the network. The UE may transmit, in response to the LP-WUS and in the SDT session, the at least one data packet to the network. The at least one data packet may be transmitted based at least in part on the control information. Numerous other aspects are described.

### CROSS-REFERENCE TO RELATED APPLICATION

This patent application claims priority to U.S. Provisional Patent Application No. 63/672,401, filed on Jul. 17, 2024, entitled “RETRANSMISSIONS IN SMALL DATA TRANSMISSION SESSIONS WITH A LOW-POWER WAKE-UP SIGNAL,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods for retransmissions in small data transmission sessions with a low-power wake-up signal.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting, for at least one data packet, a request for a small data transmission (SDT) session with a network. The method may include receiving a low-power wake-up signal (LP-WUS) from the network. The method may include receiving, in the SDT session, control information from the network. The method may include transmitting, in response to the LP-WUS and in the SDT session, the at least one data packet to the network, where the at least one data packet is transmitted based at least in part on the control information.

Some aspects described herein relate to a method of wireless communication performed by a network node. The method may include receiving a request for an SDT session with a UE. The method may include transmitting an LP-WUS to the UE. The method may include transmitting, in the SDT session, control information to the UE. The method may include monitoring, in the SDT session, for at least one data packet from the UE, where the network node monitors for the at least one data packet based at least in part on the control information.

Some aspects described herein relate to a method of wireless communication performed by a UE. The method may include receiving a paging message requesting an SDT session with a network. The method may include receiving an LP-WUS from the network. The method may include receiving, in the SDT session, control information from the network. The method may include monitoring, in response to the LP-WUS and in the SDT session, for at least one data packet from the network, where the UE monitors for the at least one data packet based at least in part on the control information.

Some aspects described herein relate to a method of wireless communication performed by a network node. The method may include transmitting, for at least one data packet, a paging message requesting an SDT session with a UE. The method may include transmitting an LP-WUS to the UE. The method may include transmitting, in the SDT session, control information to the UE. The method may include transmitting, in the SDT session, the at least one data packet to the UE, where the at least one data packet is transmitted based at least in part on the control information.

Some aspects described herein relate to a UE. The UE may include a processing system. The processing system may include one or more processors and one or more code storing memories coupled with the one or more processors. The processing system may be configured to cause the UE to transmit, for at least one data packet, a request for an SDT session with a network. The processing system may be configured to cause the UE to receive an LP-WUS from the network. The processing system may be configured to cause the UE to receive, in the SDT session, control information from the network. The processing system may be configured to cause the UE to transmit, in response to the LP-WUS and in the SDT session, the at least one data packet to the network, where the at least one data packet is transmitted based at least in part on the control information.

Some aspects described herein relate to a network node. The network node may include a processing system. The processing system may include one or more processors and one or more code storing memories coupled with the one or more processors. The processing system may be configured to cause the network node to receive a request for an SDT session with a UE. The processing system may be configured to cause the network node to transmit an LP-WUS to the UE. The processing system may be configured to cause the network node to transmit, in the SDT session, control information to the UE. The processing system may be configured to cause the network node to monitor, in the SDT session, for at least one data packet from the UE, where the network node monitors for the at least one data packet based at least in part on the control information.

Some aspects described herein relate to a UE. The UE may include a processing system. The processing system may include one or more processors and one or more code storing memories coupled with the one or more processors. The processing system may be configured to cause the UE to receive a paging message requesting an SDT session with a network. The processing system may be configured to cause the UE to receive an LP-WUS from the network. The processing system may be configured to cause the UE to receive, in the SDT session, control information from the network. The processing system may be configured to cause the UE to monitor, in response to the LP-WUS and in the SDT session, for at least one data packet from the network, where the UE monitors for the at least one data packet based at least in part on the control information.

Some aspects described herein relate to a network node. The network node may include a processing system. The processing system may include one or more processors and one or more code storing memories coupled with the one or more processors. The processing system may be configured to cause the network node to transmit, for at least one data packet, a paging message requesting an SDT session with a UE. The processing system may be configured to cause the network node to transmit an LP-WUS to the UE. The processing system may be configured to cause the network node to transmit, in the SDT session, control information to the UE. The processing system may be configured to cause the network node to transmit, in the SDT session, the at least one data packet to the UE, where the at least one data packet is transmitted based at least in part on the control information.

Some aspects described herein relate to a non-transitory computer-readable medium that stores a set of instructions for wireless communication by a UE. The set of instructions, when executed by one or more processors of the UE, may cause the UE to transmit, for at least one data packet, a request for an SDT session with a network. The set of instructions, when executed by one or more processors of the UE, may cause the UE to receive an LP-WUS from the network. The set of instructions, when executed by one or more processors of the UE, may cause the UE to receive, in the SDT session, control information from the network. The set of instructions, when executed by one or more processors of the UE, may cause the UE to transmit, in response to the LP-WUS and in the SDT session, the at least one data packet to the network, where the at least one data packet is transmitted based at least in part on the control information.

Some aspects described herein relate to a non-transitory computer-readable medium that stores a set of instructions for wireless communication by a network node. The set of instructions, when executed by one or more processors of the network node, may cause the network node to receive a request for an SDT session with a UE. The set of instructions, when executed by one or more processors of the network node, may cause the network node to transmit an LP-WUS to the UE. The set of instructions, when executed by one or more processors of the network node, may cause the network node to transmit, in the SDT session, control information to the UE. The set of instructions, when executed by one or more processors of the network node, may cause the network node to monitor, in the SDT session, for at least one data packet from the UE, where the network node monitors for the at least one data packet based at least in part on the control information.

Some aspects described herein relate to a non-transitory computer-readable medium that stores a set of instructions for wireless communication by a UE. The set of instructions, when executed by one or more processors of the UE, may cause the UE to receive a paging message requesting an SDT session with a network. The set of instructions, when executed by one or more processors of the UE, may cause the UE to receive an LP-WUS from the network. The set of instructions, when executed by one or more processors of the UE, may cause the UE to receive, in the SDT session, control information from the network. The set of instructions, when executed by one or more processors of the UE, may cause the UE to monitor, in response to the LP-WUS and in the SDT session, for at least one data packet from the network, where the UE monitors for the at least one data packet based at least in part on the control information.

Some aspects described herein relate to a non-transitory computer-readable medium that stores a set of instructions for wireless communication by a network node. The set of instructions, when executed by one or more processors of the network node, may cause the network node to transmit, for at least one data packet, a paging message requesting an SDT session with a UE. The set of instructions, when executed by one or more processors of the network node, may cause the network node to transmit an LP-WUS to the UE. The set of instructions, when executed by one or more processors of the network node, may cause the network node to transmit, in the SDT session, control information to the UE. The set of instructions, when executed by one or more processors of the network node, may cause the network node to transmit, in the SDT session, the at least one data packet to the UE, where the at least one data packet is transmitted based at least in part on the control information.

Some aspects described herein relate to an apparatus for wireless communication. The apparatus may include means for transmitting, for at least one data packet, a request for an SDT session with a network. The apparatus may include means for receiving an LP-WUS from the network. The apparatus may include means for receiving, in the SDT session, control information from the network. The apparatus may include means for transmitting, in response to the LP-WUS and in the SDT session, the at least one data packet to the network, where the at least one data packet is transmitted based at least in part on the control information.

Some aspects described herein relate to an apparatus for wireless communication. The apparatus may include means for receiving a request for an SDT session with a UE. The apparatus may include means for transmitting an LP-WUS to the UE. The apparatus may include means for transmitting, in the SDT session, control information to the UE. The apparatus may include means for monitoring, in the SDT session, for at least one data packet from the UE, where the network node monitors for the at least one data packet based at least in part on the control information.

Some aspects described herein relate to an apparatus for wireless communication. The apparatus may include means for receiving a paging message requesting an SDT session with a network. The apparatus may include means for receiving an LP-WUS from the network. The apparatus may include means for receiving, in the SDT session, control information from the network. The apparatus may include means for monitoring, in response to the LP-WUS and in the SDT session, for at least one data packet from the network, where the UE monitors for the at least one data packet based at least in part on the control information.

Some aspects described herein relate to an apparatus for wireless communication. The apparatus may include means for transmitting, for at least one data packet, a paging message requesting an SDT session with a UE. The apparatus may include means for transmitting an LP-WUS to the UE. The apparatus may include means for transmitting, in the SDT session, control information to the UE. The apparatus may include means for transmitting, in the SDT session, the at least one data packet to the UE, where the at least one data packet is transmitted based at least in part on the control information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment in a wireless network.

FIG. 3 is a diagram illustrating an example disaggregated base station architecture.

FIG. 4 is a diagram illustrating an example of a low-power wake-up radio and a low-power wake-up signal (LP-WUS).

FIG. 5 is a diagram of an example associated with mobile originated retransmissions in a small data transmission (SDT) session using LP-WUSs.

FIG. 6 is a diagram of an example associated with mobile terminated retransmissions in an SDT session using LP-WUSs.

FIG. 7 is a diagram of an example associated with mobile originated retransmissions in an SDT session using a configured grant.

FIG. 8 is a diagram of an example associated with mobile originated retransmissions in an SDT session using a retransmission timer.

FIG. 9 is a diagram of an example associated with mobile terminated retransmissions in an SDT session using a retransmission timer.

FIG. 10 is a diagram of an example associated with mobile originated retransmissions in an SDT session using a retransmission timer and a hybrid automatic repeat request (HARQ) timer.

FIG. 11 is a diagram of an example associated with mobile terminated retransmissions in an SDT session using a retransmission timer and a HARQ timer.

FIGS. 12, 13, 14, and 15 are diagrams illustrating example processes associated with retransmissions in SDT sessions with an LP-WUS.

FIGS. 16 and 17 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may use an inactive state (e.g., a radio resource control (RRC) inactive state in which the UE still performs periodic measurements and monitors for paging messages) to conserve power and processing resources when the UE does not have data to transmit to, or receive from, a network (e.g., via a network node of the network). However, the UE may have a small amount of data to transmit to the network while in the inactive state. To avoid overhead associated with an active state (e.g., an RRC active state) for the UE, the UE may transmit the small amount of data to the network in a small data transmission (SDT) session (e.g., when the small amount of data satisfies a size threshold associated with the SDT session). Similarly, the network may have a small amount of data to transmit to the UE in the inactive state, and the network may transmit the small amount of data to the UE in an SDT session.

To further increase power saving, the UE may include a main radio (MR) (also referred to as a “main receiver”) and a low-power wake-up radio (LP-WUR) (also referred to as a “low-power wake-up receiver”). The UE may disable all (or a portion of) the hardware elements of the MR in order to conserve power (e.g., according to a discontinuous reception (DRX) cycle). Accordingly, the UE may use the LP-WUR to monitor for a low-power wake-up signal (LP-WUS), such as an on-off keying (OOK) signal or another similar type of signal, that triggers to the UE to activate the MR.

Various aspects relate generally to combining an LP-WUS with an SDT session. Some aspects more specifically relate to retransmissions in an SDT session triggered by an LP-WUS. In one example, a retransmission may be triggered by an additional LP-WUS. In another example, a retransmission may be triggered by a timer associated with retransmission. In some aspects, the UE may deactivate an MR of the UE during a timer associated with a minimum duration before a retransmission grant is expected.

Particular aspects of the subject matter described in this disclosure can be implemented to realize one or more of the following potential advantages. In some examples, because an LP-WUS is combined with an SDT session, the described techniques can be used to conserve power and processing resources at a UE outside of the SDT session because the UE may deactivate an MR outside of the SDT session. In some examples, because a retransmission is triggered by an additional LP-WUS, the described techniques can be used to conserve processing resources during the SDT session because each transmission is triggered by a corresponding LP-WUS. In some examples, because a retransmission is triggered by a timer associated with retransmission, the described techniques can be used to reduce latency associated with the retransmission. In some examples, because the UE may deactivate the MR during a timer associated with a minimum duration before a retransmission grant is expected, the described techniques can be used to conserve power and processing resources at the UE during the SDT session.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

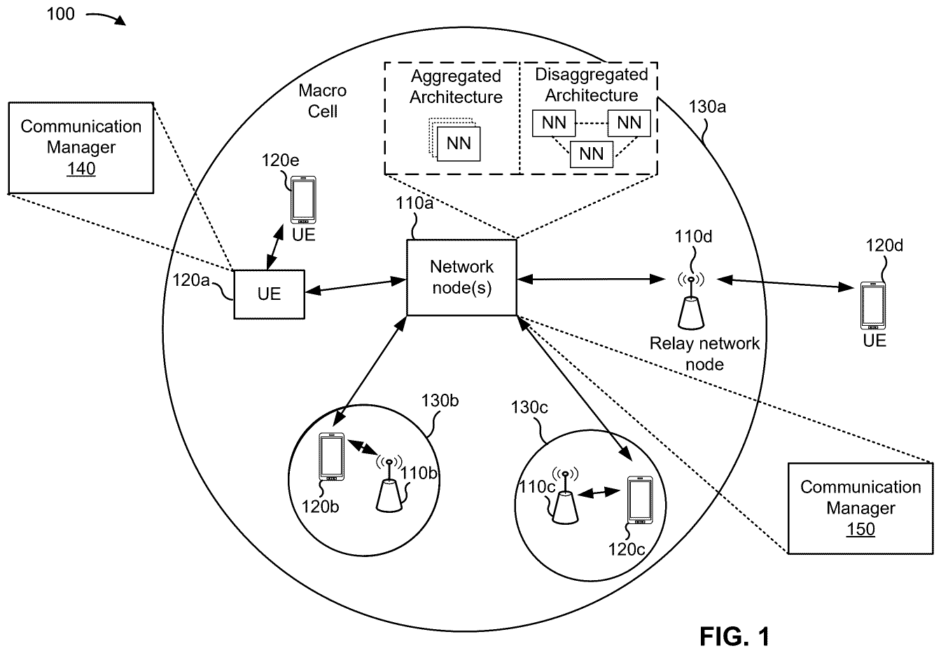

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GH2), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced MTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, for at least one data packet, a request for an SDT session with a network (e.g., via the network node 110); receive an LP-WUS from the network; receive, in the SDT session, control information from the network; and transmit, in response to the LP-WUS and in the SDT session, the at least one data packet to the network, where the at least one data packet is transmitted based at least in part on the control information. Additionally, or alternatively, and as described in more detail elsewhere herein, the communication manager 140 may receive a paging message requesting an SDT session with a network (e.g. via the network node 110); receive an LP-WUS from the network; receive, in the SDT session, control information from the network; and monitor, in response to the LP-WUS and in the SDT session, for at least one data packet from the network, where the UE 120 monitors for the at least one data packet based at least in part on the control information. Additionally, or alternatively, the communication manager 140 may perform one or more other operations described herein.

In some aspects, the network node 110 may include a communication manager 150. As described in more detail elsewhere herein, the communication manager 150 may receive a request for an SDT session with a UE (e.g., the UE 120); transmit an LP-WUS to the UE; transmit, in the SDT session, control information to the UE; and monitor, in the SDT session, for at least one data packet from the UE, where the network node 110 monitors for the at least one data packet based at least in part on the control information. Additionally, or alternatively, and as described in more detail elsewhere herein, the communication manager 150 may transmit, for at least one data packet, a paging message requesting an SDT session with a UE (e.g., the UE 120); transmit an LP-WUS to the UE; transmit, in the SDT session, control information to the UE; and transmit, in the SDT session, the at least one data packet to the UE, where the at least one data packet is transmitted based at least in part on the control information. Additionally, or alternatively, the communication manager 150 may perform one or more other operations described herein.

As indicated above, FIG. 1 is provided as an example. Other examples may differ from what is described with regard to FIG. 1.

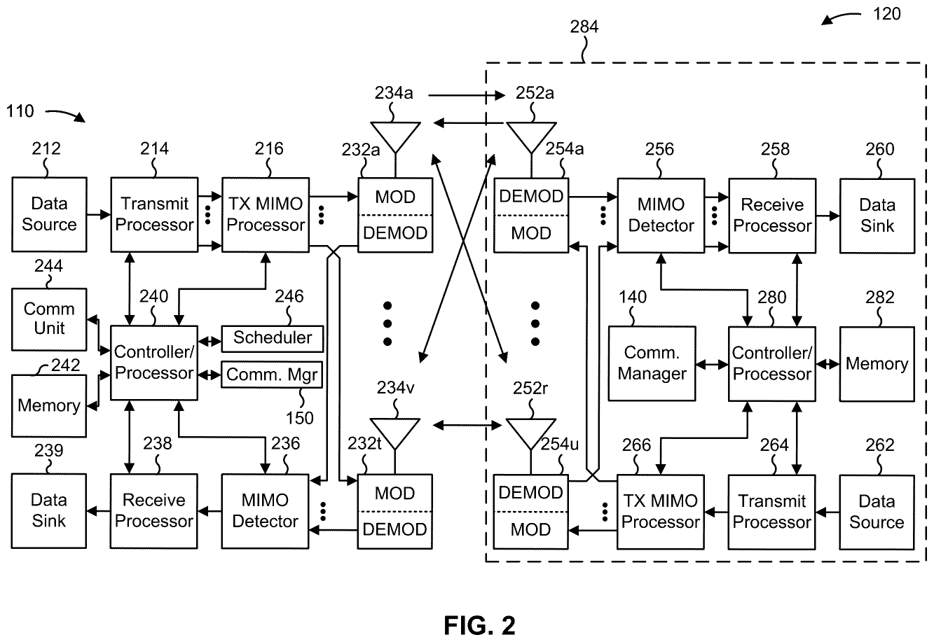

FIG. 2 is a diagram illustrating an example network node 110 in communication with an example UE 120 in a wireless network. As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

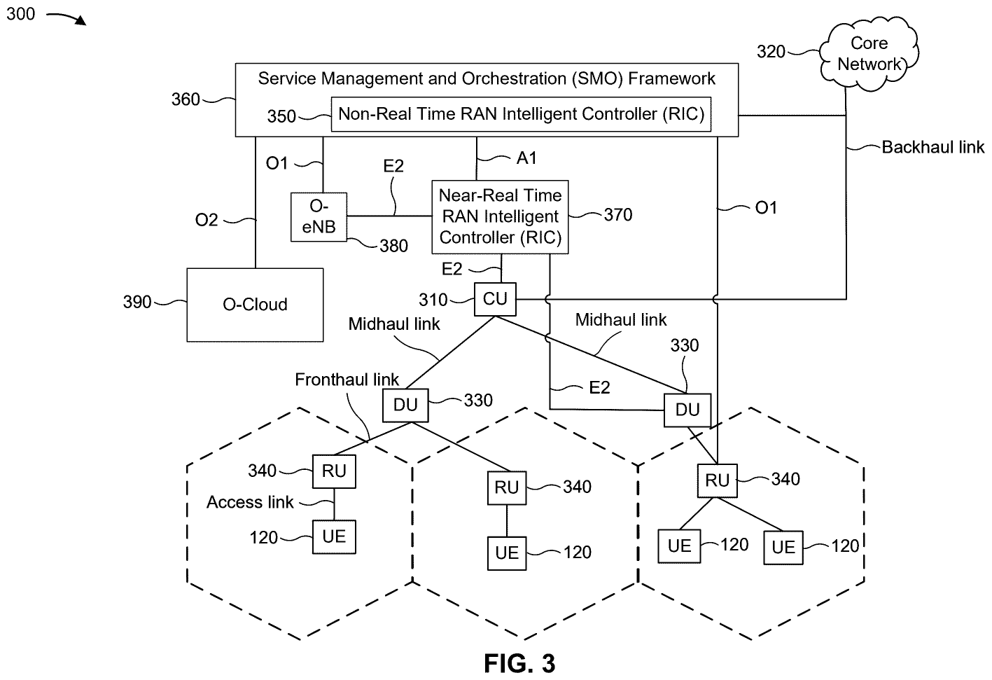

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

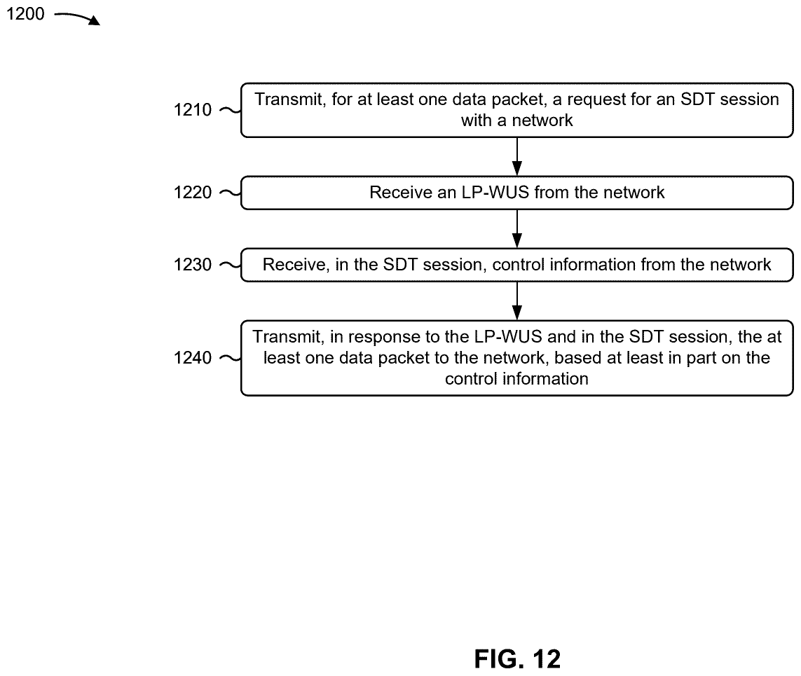

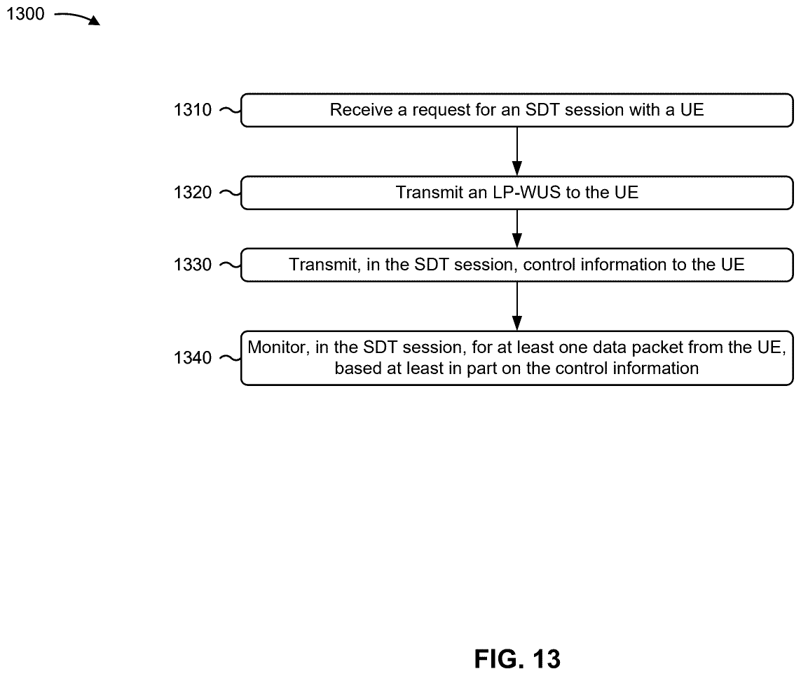

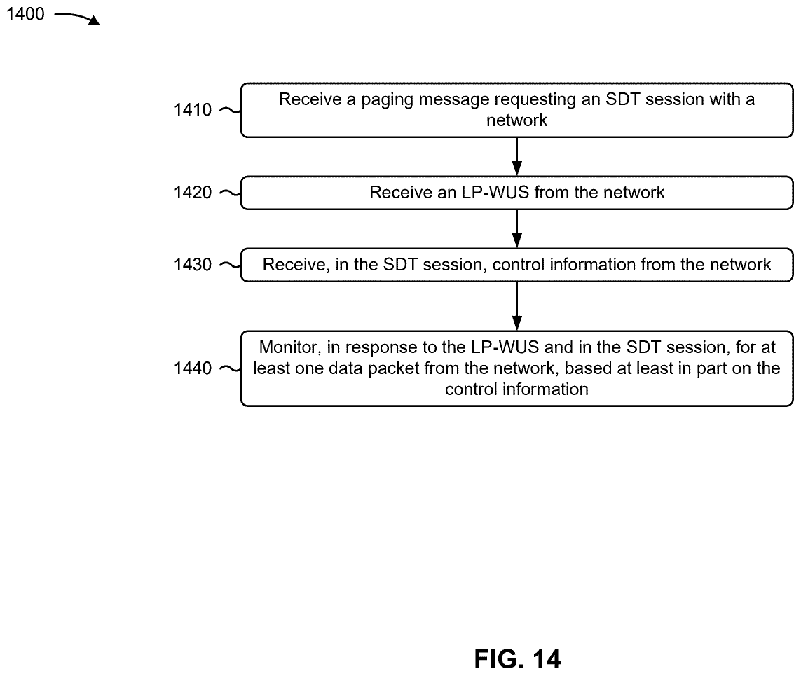

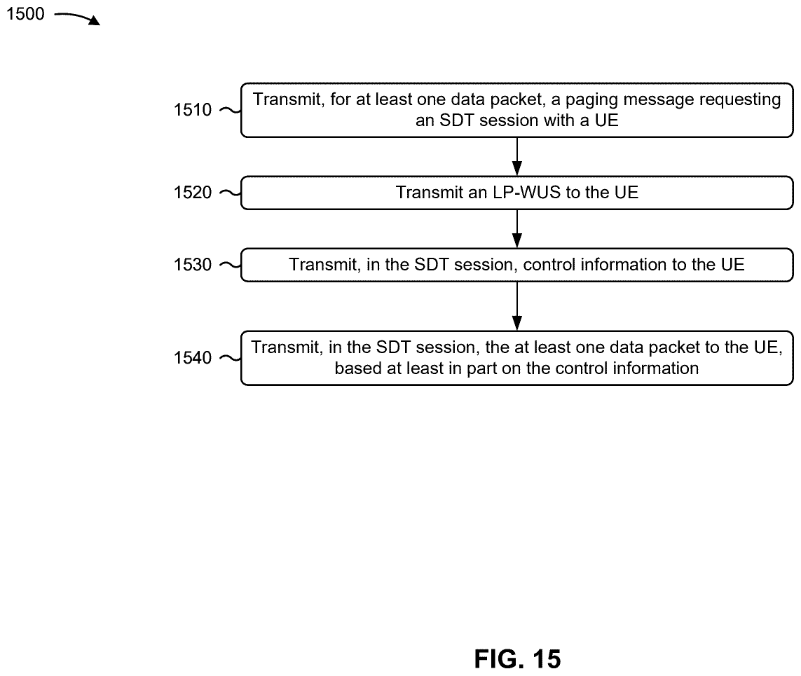

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with retransmissions in SDT sessions with an LP-WUS, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1200 of FIG. 12, process 1300 of FIG. 13, process 1400 of FIG. 14, process 1500 of FIG. 15, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, process 1400 of FIG. 14, process 1500 of FIG. 15, or other processes as described herein. In some examples, executing instructions may include running the instructions, converting the instructions, compiling the instructions, and/or interpreting the instructions, among other examples.

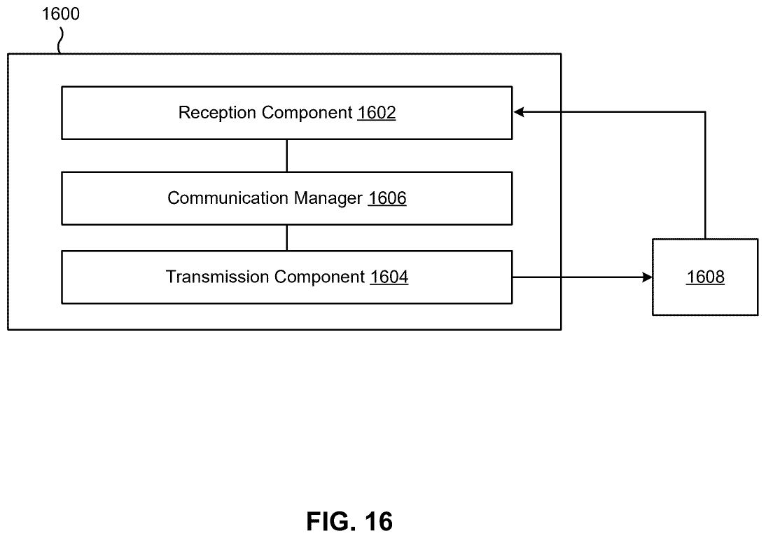

In some aspects, a UE (e.g., the UE 120 and/or apparatus 1600 of FIG. 16) may include means for transmitting, for at least one data packet, a request for an SDT session with a network; means for receiving an LP-WUS from the network; means for receiving, in the SDT session, control information from the network; and/or means for transmitting, in response to the LP-WUS and in the SDT session, the at least one data packet to the network, wherein the at least one data packet is transmitted based at least in part on the control information. Additionally, or alternatively, the UE may include means for receiving a paging message requesting an SDT session with a network; means for receiving an LP-WUS from the network; means for receiving, in the SDT session, control information from the network; and/or means for monitoring, in response to the LP-WUS and in the SDT session, for at least one data packet from the network, wherein the UE monitors for the at least one data packet based at least in part on the control information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

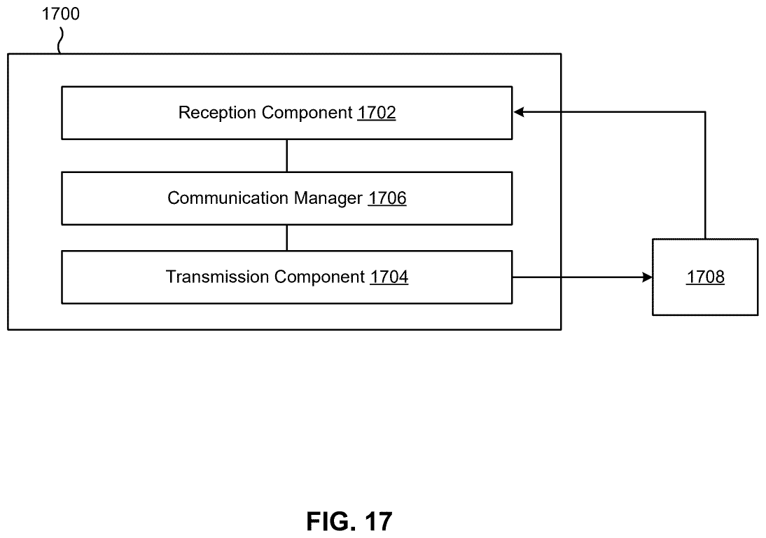

In some aspects, a network node (e.g., the network node 110, the RU 340, the DU 330, the CU 310, and/or apparatus 1700 of FIG. 17) may include means for receiving a request for an SDT session with a UE; means for transmitting an LP-WUS to the UE; means for transmitting, in the SDT session, control information to the UE; and/or means for monitoring, in the SDT session, for at least one data packet from the UE, wherein the network node monitors for the at least one data packet based at least in part on the control information. Additionally, or alternatively, the network node may include means for transmitting, for at least one data packet, a paging message requesting an SDT session with a UE; means for transmitting an LP-WUS to the UE; means for transmitting, in the SDT session, control information to the UE; and/or means for transmitting, in the SDT session, the at least one data packet to the UE, wherein the at least one data packet is transmitted based at least in part on the control information. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

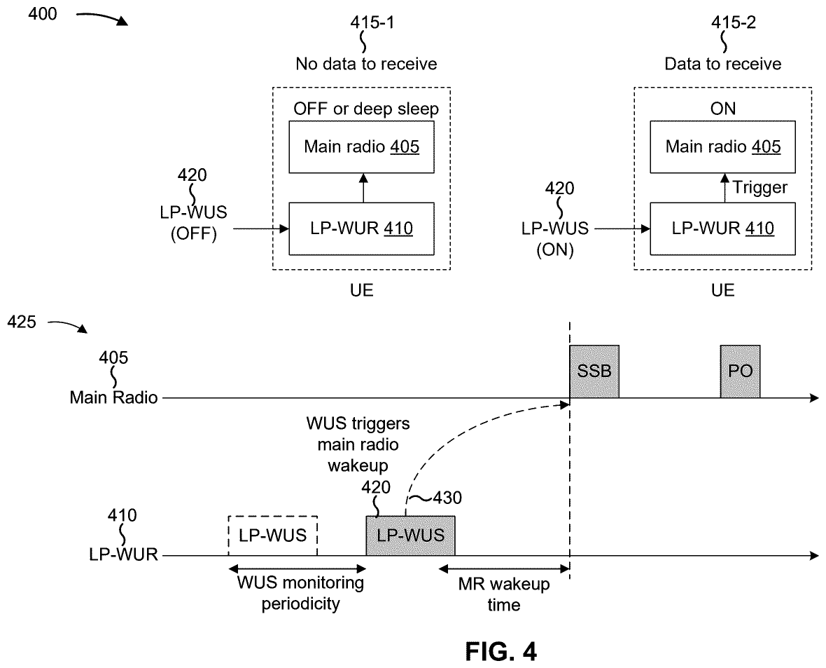

FIG. 4 is a diagram illustrating an example 400 of an LP-WUR and an LP-WUS. As shown in FIG. 4, a UE (such as UE 120) may be equipped with a communication system that includes a main radio (illustrated as “MR”) 405 and an LP-WUR 410 to reduce power consumption and enable low latency. For example, power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency can lead to increased power consumption. Accordingly, as shown in FIG. 4, the UE may be equipped with the LP-WUR 410, which may be considered a companion receiver that can be used with a main radio 405 to reduce power consumption and latency.

For example, in some aspects, the UE may generally use the main radio 405 to transmit and/or receive user data, and the main radio 405 may be turned off or operated in a deep sleep state unless there is user data to transmit and/or receive. Furthermore, the LP-WUR 410 may serve as a simple wake-up receiver for the main radio 405, and the LP-WUR 410 may be active and monitoring for an LP-WUS while the main radio 405 is off or in the deep sleep state. For example, reference number 415-1 depicts a first state associated with the main radio 405 and the LP-WUR 410 where there is no user data to be provided to the main radio 405. In such cases, the main radio 405 may be off or operated in the deep sleep state unless there is user data to transmit, and the LP-WUR 410 may monitor for an LP-WUS (for example, continuously, or periodically in monitoring occasions that are separated in time). Furthermore, reference number 415-2 depicts a second state associated with the main radio 405 and the LP-WUR 410 where there is user data for the main radio 405. In such cases, the LP-WUR 410 may receive an LP-WUS 420 (such as from a network node 110) and may provide a trigger to wake or otherwise activate the main radio 405 based on detecting the LP-WUS 420. Accordingly, the main radio 405 may then transmit and/or receive user data.

In general, the LP-WUR 410 may consume very little power (for example a target power consumption less than 100 microwatts (μW) in the active state), which may be achieved using simple modulation schemes (for example, OOK), a narrow bandwidth (for example, less than 5 MHz), and/or other suitable techniques. In this way, the LP-WUR 410 can be used to reduce the time that the main radio 405 spends in an on state and/or may avoid unnecessarily waking the main radio 405 from the off or deep sleep state when there is no user data to transmit or receive, which tends to be costly from a power consumption perspective. Furthermore, because the LP-WUR 410 has a very low power consumption, the LP-WUR 410 can be used to frequently or continuously perform LP-WUS monitoring, which may improve latency because the main radio 405 can be woken up when there is user data that the main radio 405 needs to receive. For example, the LP-WUR 410 may not suffer from the latency versus power efficiency tradeoff associated with duty cycling schemes, such as DRX. Furthermore, in addition to performing LP-WUS monitoring, which may be used for paging reception, the LP-WUR 410 may monitor a low power synchronization signal (LP-SS) for time and frequency tracking and radio resource management (RRM) measurement. In this way, by monitoring the LP-SS, serving cell and/or neighbor cell monitoring can be offloaded from the main radio 405 to the LP-WUR 410 to reduce how often the main radio 405 is woken up, which can further reduce power consumption.

In some aspects, the LP-WUR 410 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 405.

In some aspects, the LP-WUR 410 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 425, one application of the LP-WUR 410 is to monitor the LP-WUS 420 for paging monitoring, which can be used to reduce unnecessary paging reception performed by the main radio 405. For example, as shown in FIG. 4, the LP-WUR 410 may be configured to monitor for an LP-WUS 420 (while the main radio 405 is off or in a deep sleep state) according to a WUS monitoring periodicity. For example, the LP-WUR 410 may monitor for the LP-WUS 420 in periodic LP-WUS monitoring occasions that are spaced in time according to the WUS monitoring periodicity. Alternatively, although not explicitly shown in FIG. 4, the LP-WUR 410 may be configured to continuously monitor for the LP-WUS 420. In general, a network node may transmit an LP-WUS 420 to a UE only in cases where there is a paging message that needs to be sent to the UE while the UE is in an idle or inactive state (such as an RRC idle or RRC inactive state). In such cases, as shown by reference number 430, the LP-WUR 410 may receive and detect the LP-WUS 420, which may trigger the LP-WUR 410 to wake up the main radio 405. In some aspects, the LP-WUS 420 may be a sequence-based WUS, which may include a predefined set of sequences (implemented, for example, using OOK modulation and/or phase modulation). As shown, the main radio 405 may wake up after a main radio wake-up time, and may then start to monitor one or more synchronization signal block (SSB) transmissions to obtain synchronization with the network node before monitoring and receiving the paging message in a subsequent PO. Otherwise, in cases where the LP-WUR 410 does not detect the LP-WUS 420, the main radio 405 may remain in the deep sleep state to save power.

In some aspects, the LP-WUS 420 may be used in combination with an SDT session. For example, the network node 110 may transmit the LP-WUS 420 in order to trigger the UE 120 to activate the main radio 405 and initiate the SDT session (e.g., by monitoring for control information from the network node 110). As a result, the UE 120 may conserve additional power and processing resources outside the SDT session by deactivating the main radio 405.

As indicated above, FIG. 4 is provided as an example. Other examples may differ from what is described with regard to FIG. 4.

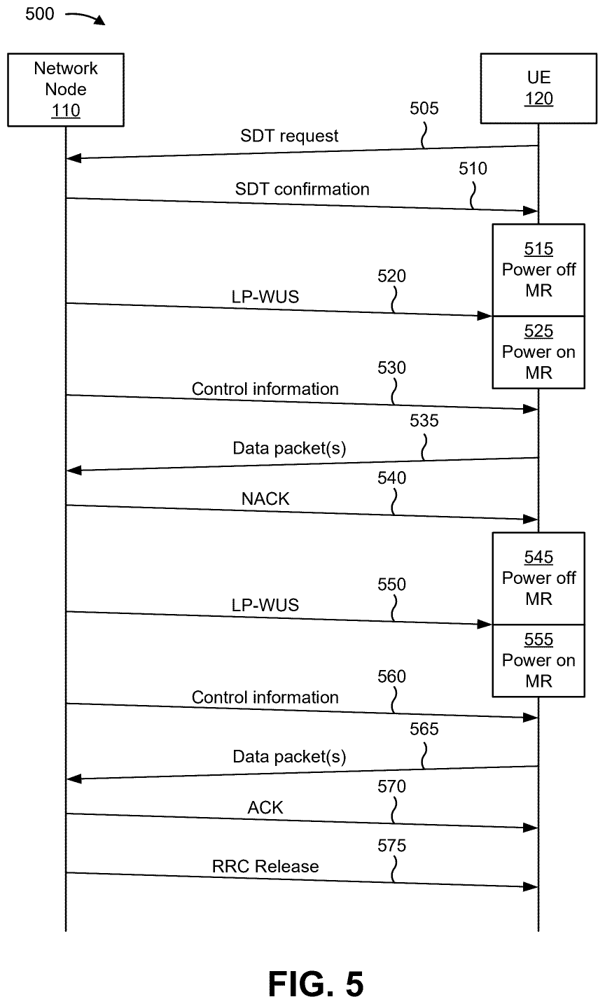

FIG. 5 is a diagram of an example 500 associated with mobile originated retransmissions in an SDT session using LP-WUSs. As shown in FIG. 5, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 505, the UE 120 may transmit, and the network node 110 may receive (e.g., directly or via the RU 340), a request for an SDT session with a network (including the network node 110). The request may be for at least one data packet (e.g., queued for transmission to the network node 110 by the UE 120). The at least one data packet may satisfy a size threshold such that the UE 120 transmits the request for the SDT session based at least in part on the size threshold being satisfied.

In some aspects, the request may be included in an RRC resume request (e.g., an RRCResume message, as defined in 3GPP specifications). In some aspects, the UE 120 may transmit the request using a random access occasion (e.g., for random access SDT (RA-SDT)), which may be configured by system information from the network node 110. Alternatively, the UE 120 may transmit the request using a configured grant occasion (e.g., for configured grant SDT (CG-SDT)), which may be configured by an RRC release message from the network node 110 (e.g., an RRCRelease message, as defined in 3GPP specifications).

As shown by reference number 510, the network node 110 may transmit (e.g., directly or via the RU 340), and the UE 120 may receive, a confirmation of the SDT session. For example, the confirmation may comprise DCI (e.g., scrambled with a cell radio network temporary identifier (C-RNTI) associated with the UE 120).

As shown by reference number 515, the UE 120 may power off an MR of the UE 120. For example, the UE 120 may power on the MR in order to transmit the request for the SDT session (in a random access occasion or a CG occasion, as described above) and may power off the MR after receiving the confirmation of the SDT session in order to await an LP-WUS from the network node 110. The LP-WUS may initiate the SDT session.

As shown by reference number 520, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 525. Powering on the MR of the UE 120 may take some time (e.g., a number of milliseconds (ms), represented by Y). In some aspects, the UE 120 may report (to the network node) the time to power on the MR; therefore, the network node 110 may refrain from transmitting to the UE 120 after the LP-WUS until the time to power on the MR has passed.

As shown by reference number 530, the network node may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (from the UE 120 to the network node 110). The control information may be received in the SDT session. In some aspects, in response to the control information, the UE 120 may extend an amount of time for which the MR is powered on. For example, the UE 120 may, by default, power on the MR for at least a first number of ms (e.g., represented by X) but may extend the MR being powered on for at least a second number of ms (e.g., represented by Z) after receiving (and decoding) the control information. Alternatively, the UE 120 may power on the MR for a fixed amount of time.

As shown by reference number 535, the UE 120 may transmit, and the network node 110 may monitor for (e.g., directly or via the RU 340), the at least one data packet. The UE 120 may transmit the at least one data packet using a PUSCH. The UE 120 may transmit the at least one data packet based at least in part on the control information. For example, the control information may indicate a set of resources (e.g., in time, frequency, and/or space) for transmitting the at least one data packet.

As shown by reference number 540, the network node 110 may transmit (e.g., directly or via the RU 340), and the UE 120 may receive, a negative acknowledgement (NACK). The network node 110 may transmit the NACK in response to failing to receive or decode the at least one data packet. In some aspects, the NACK may include a hybrid automatic repeat request (HARQ) signal. Additionally, or alternatively, the NACK may be included in DCI. Accordingly, the network node 110 may transmit the NACK using a PDCCH.

As shown by reference number 545, the UE 120 may power off the MR of the UE 120. For example, the UE 120 may power off the MR after receiving the NACK in order to await an additional LP-WUS from the network node 110 (e.g., to initiate a retransmission of the at least one data packet).

As shown by reference number 550, the network node 110 may transmit (e.g., directly or via the RU 340), and the UE 120 may receive (e.g., using the LP-WUR of the UE 120), the additional LP-WUS. In response to the additional LP-WUS, the UE 120 may power on the MR of the UE 120, as shown by reference number 555. As described above, the network node 110 may refrain from transmitting to the UE 120 after the additional LP-WUS until the time to power on the MR has passed.

As shown by reference number 560, the network node may transmit (e.g., directly or via the RU 340), and the UE 120 may receive (e.g., using the MR), additional control information. The network node 110 may transmit the additional control information using a PDCCH. For example, the additional control information may comprise DCI that schedules retransmission of the at least one data packet (from the UE 120 to the network node 110). The additional control information may be received in the SDT session. In some aspects, in response to the additional control information, the UE 120 may extend an amount of time for which the MR is powered on, as described above. Alternatively, the UE 120 may power on the MR for a fixed amount of time.

As shown by reference number 565, the UE 120 may transmit, and the network node 110 may monitor for (e.g., directly or via the RU 340), a retransmission of the at least one data packet. The UE 120 may retransmit the at least one data packet using a PUSCH. The UE 120 may retransmit the at least one data packet based at least in part on the additional control information. For example, the additional control information may indicate a set of resources (e.g., in time, frequency, and/or space) for retransmitting the at least one data packet.

As shown by reference number 570, the network node may transmit (e.g., directly or via the RU 340), and the UE 120 may receive, an acknowledgement (ACK). The network node 110 may transmit the ACK in response to receiving and decoding the at least one data packet. In some aspects, the ACK may include a HARQ signal. Additionally, or alternatively, the ACK may be included in DCI. Accordingly, the network node 110 may transmit the ACK using a PDCCH.

Although the example 500 is shown with a single retransmission, other examples may include multiple retransmissions. For example, the network node 110 may fail to receive and decode a first retransmission of the at least one data packet, and thus operations described in connection with reference numbers 540, 545, 550, 555, 560, and 565 may be repeated in order to perform a second retransmission.

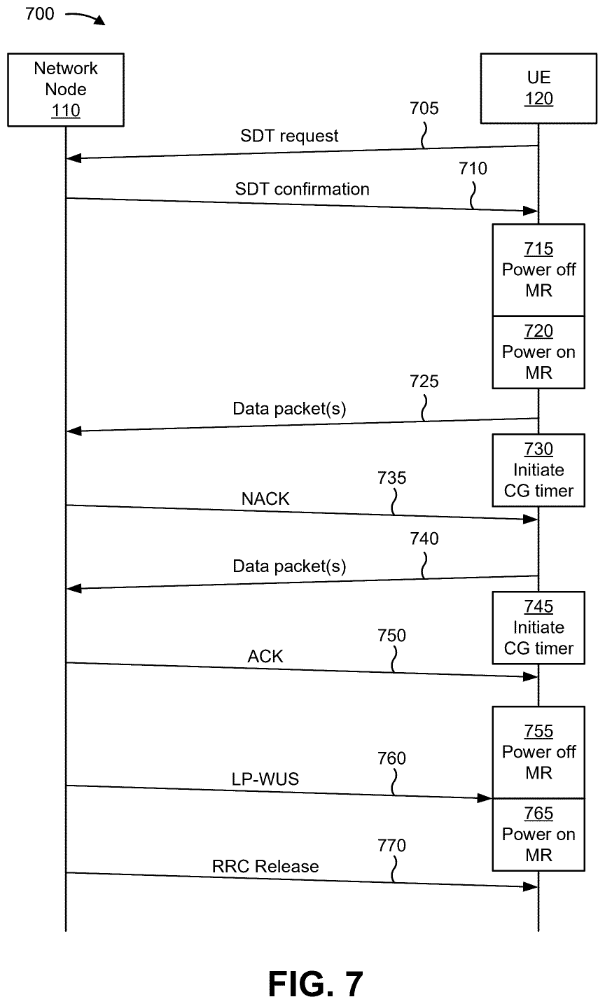

As shown by reference number 575, the network node may transmit (e.g., directly or via the RU 340), and the UE 120 may receive, an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 500 is shown with the UE 120 receiving the RRC release message shortly after the ACK, other examples may include the network node 110 using another LP-WUS to trigger the UE 120 to power on the MR in order to receive the RRC release message (e.g., as described in connection with FIG. 7).

By using techniques as described in connection with FIG. 5, the UE 120 conserves power and processing resources outside of the SDT session because the UE 120 may deactivate the MR outside of the SDT session. Additionally, the retransmission is triggered by the additional LP-WUS, which may conserve processing resources during the SDT session because behavior of the UE 120 in response to the LP-WUS is not modified by the NACK.

As indicated above, FIG. 5 is provided as an example. Other examples may differ from what is described with respect to FIG. 5.

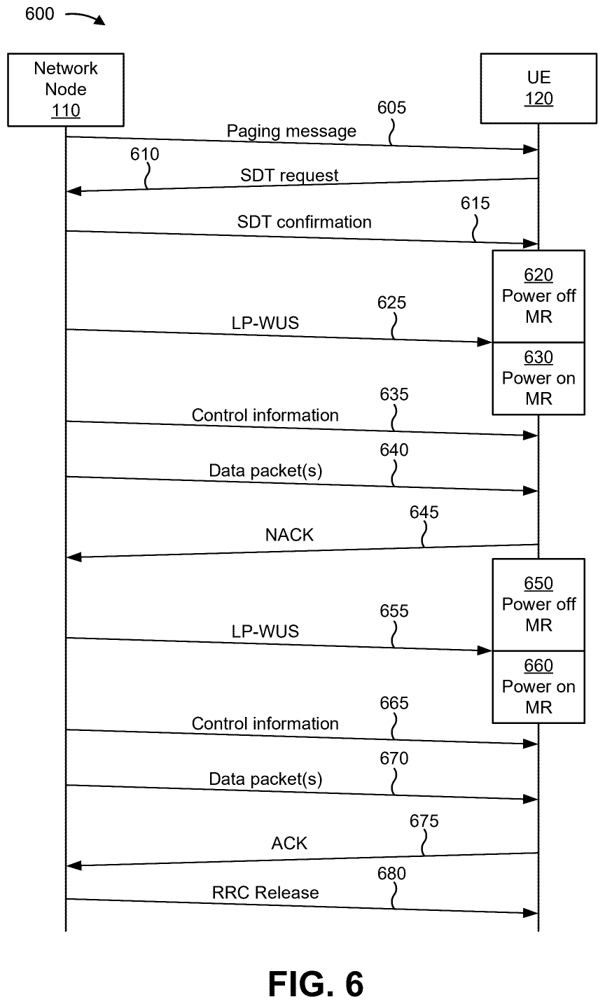

FIG. 6 is a diagram of an example 600 associated with mobile terminated retransmissions in an SDT session using LP-WUSs. As shown in FIG. 6, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 605, the network node 110 may transmit (e.g., directly or via the RU 340), and the UE 120 may receive, a paging message requesting an SDT session with a network. For example, the paging message may include a cause value associated with SDT. The paging message may be for at least one data packet (e.g., queued for transmission to the UE 120 from the network node 110). The at least one data packet may satisfy a size threshold such that the network node 110 transmits the paging message based at least in part on the size threshold being satisfied.

As shown by reference number 610, the UE 120 may transmit, and the network node 110 may receive (e.g., directly or via the RU 340), a request for the SDT session with a network (including the network node 110). The UE 120 may transmit the request in response to the paging message. Additionally, a signal strength measured by the UE 120 (e.g., an RSRP value, among other examples) may satisfy a strength threshold such that the UE 120 may transmit the request based at least in part on the strength threshold being satisfied.

As shown by reference number 615, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 620, the UE 120 may power off an MR of the UE 120. For example, the UE 120 may power on the MR in order to receive the paging message and transmit the request for the SDT session and may power off the MR after receiving the confirmation of the SDT session in order to await an LP-WUS from the network node 110. The LP-WUS may initiate the SDT session.

As shown by reference number 625, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 630. The network node 110 may refrain from transmitting to the UE 120 after the LP-WUS until a time to power on the MR has passed (e.g., as described in connection with FIG. 5).

As shown by reference number 635, the network node 110 may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (to the UE 120 from the network node 110). The control information may be received in the SDT session. In some aspects, in response to the control information, the UE 120 may extend an amount of time for which the MR is powered on (e.g., as described in connection with FIG. 5). Alternatively, the UE 120 may power on the MR for a fixed amount of time.

As shown by reference number 640, the network node 110 may transmit (e.g., directly or via the RU 340), and the UE 120 may monitor for, the at least one data packet. The network node 110 may transmit the at least one data packet using a PDSCH. The network node 110 may transmit the at least one data packet based at least in part on the control information. For example, the control information may indicate a set of resources (e.g., in time, frequency, and/or space) for transmitting the at least one data packet.

As shown by reference number 645, the UE 120 may transmit, and the network node 110 may receive (e.g., directly or via the RU 340), a NACK. The UE 120 may transmit the NACK in response to failing to receive or decode the at least one data packet. In some aspects, the NACK may include a HARQ signal. Additionally, or alternatively, the NACK may be included in UCI. Accordingly, the UE 120 may transmit the NACK using a PUCCH or a PUSCH.

As shown by reference number 650, the UE 120 may power off the MR of the UE 120. For example, the UE 120 may power off the MR after transmitting the NACK in order to await an additional LP-WUS from the network node 110 (e.g., to initiate a retransmission of the at least one data packet).

As shown by reference number 655, the network node 110 may transmit (e.g., directly or via the RU 340), and the UE 120 may receive (e.g., using the LP-WUR of the UE 120), the additional LP-WUS. In response to the additional LP-WUS, the UE 120 may power on the MR of the UE 120, as shown by reference number 660. As described above, the network node 110 may refrain from transmitting to the UE 120 after the additional LP-WUS until the time to power on the MR has passed.

As shown by reference number 665, the network node may transmit (e.g., directly or via the RU 340), and the UE 120 may receive (e.g., using the MR), additional control information. The network node 110 may transmit the additional control information using a PDCCH. For example, the additional control information may comprise DCI that schedules retransmission of the at least one data packet (to the UE 120 from the network node 110). The additional control information may be received in the SDT session. In some aspects, in response to the additional control information, the UE 120 may extend an amount of time for which the MR is powered on, as described above. Alternatively, the UE 120 may power on the MR for a fixed amount of time.

As shown by reference number 670, the network node 110 may transmit (e.g., directly or via the RU 340), and the UE 120 may monitor for, a retransmission of the at least one data packet. The network node 110 may retransmit the at least one data packet using a PDSCH. The network node 110 may retransmit the at least one data packet based at least in part on the additional control information. For example, the additional control information may indicate a set of resources (e.g., in time, frequency, and/or space) for retransmitting the at least one data packet.

As shown by reference number 675, the UE 120 may transmit, and the network node 110 may receive (e.g., directly or via the RU 340), an ACK. The UE 120 may transmit the ACK in response to receiving and decoding the at least one data packet. In some aspects, the ACK may include a HARQ signal. Additionally, or alternatively, the ACK may be included in UCI. Accordingly, the UE 120 may transmit the ACK using a PUCCH or a PUSCH.

Although the example 600 is shown with a single retransmission, other examples may include multiple retransmissions. For example, the UE 120 may fail to receive and decode a first retransmission of the at least one data packet, and thus operations described in connection with reference numbers 645, 650, 655, 660, 665, and 670 may be repeated in order to perform a second retransmission.

As shown by reference number 680, the network node may transmit (e.g., directly or via the RU 340), and the UE 120 may receive, an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 600 is shown with the UE 120 receiving the RRC release message shortly after the ACK, other examples may include the network node 110 using another LP-WUS to trigger the UE 120 to power on the MR in order to receive the RRC release message (e.g., as described in connection with FIG. 7).

By using techniques as described in connection with FIG. 6, the UE 120 conserves power and processing resources outside of the SDT session because the UE 120 may deactivate the MR outside of the SDT session. Additionally, the retransmission is triggered by the additional LP-WUS, which may conserve processing resources during the SDT session because behavior of the UE 120 in response to the LP-WUS is not modified by the NACK.

As indicated above, FIG. 6 is provided as an example. Other examples may differ from what is described with respect to FIG. 6.

FIG. 7 is a diagram of an example 700 associated with mobile originated retransmissions in an SDT session using a configured grant. As shown in FIG. 7, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 705, the UE 120 may transmit, and the network node 110 may receive (e.g., directly or via the RU 340), a request for an SDT session with a network (including the network node 110). The request may be for at least one data packet (e.g., queued for transmission to the network node 110 by the UE 120). The at least one data packet may satisfy a size threshold such that the UE 120 transmits the request for the SDT session based at least in part on the size threshold being satisfied.

In some aspects, the request may be included in an RRC resume request (e.g., an RRCResume message, as defined in 3GPP specifications). In some aspects, the UE 120 may transmit the request using a configured grant occasion (e.g., for CG-SDT), which may be configured by an RRC release message from the network node 110 (e.g., an RRCRelease message, as defined in 3GPP specifications). Accordingly, the UE 120 may retransmit the request based at least in part on expiry of an SDT retransmission timer (e.g., a cg-SDT-RetransmissionTimer, as defined in 3GPP specifications). For example, the UE 120 may initiate the SDT retransmission timer in response to transmitting the request, and the UE 120 may retransmit the request in response to the SDT retransmission timer expiring without the UE 120 receiving a confirmation of the SDT session (e.g., as described below). In some aspects, the network node 110 may indicate a value for the SDT retransmission timer for the UE 120 to use (e.g., via RRC configuration).

As shown by reference number 710, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 715, the UE 120 may power off an MR of the UE 120. For example, the UE 120 may power on the MR in order to transmit the request for the SDT session (in a CG occasion, as described above) and may power off the MR after receiving the confirmation of the SDT session in order to await a subsequent CG occasion. The SDT session may initiate in the subsequent CG occasion.

As shown by reference number 720, the UE 120 may power on the MR of the UE 120. As shown by reference number 725, the UE 120 may transmit, and the network node 110 may monitor for (e.g., directly or via the RU 340), the at least one data packet. The UE 120 may transmit the at least one data packet using a PUSCH. The UE 120 may transmit the at least one data packet in the subsequent CG occasion. For example, the subsequent CG occasion may indicate a set of resources (e.g., in time, frequency, and/or space) configured by the network node 110 for the UE 120 to use.

As shown by reference number 730, the UE 120 may initiate a timer associated with the CG (e.g., a configuredGrantTimer, as defined in 3GPP specifications) in response to transmitting the at least one data packet (according to the CG). In some aspects, the network node 110 may indicate, to the UE 120, a value for the timer associated with the CG (e.g., via RRC configuration). The UE 120 may monitor a PDCCH during the timer associated with the CG (e.g., while the timer is running). The UE 120 may assume that the network node 110 received (and decoded) the at least one data packet when nothing is received on the PDCCH during the timer associated with the CG.

On the other hand, as shown by reference number 735, the network node 110 may transmit (e.g., directly or via the RU 340), and the UE 120 may receive, a NACK. The network node 110 may transmit the NACK in response to failing to receive or decode the at least one data packet. The network node 110 may transmit the NACK before expiry of the timer associated with the CG. In some aspects, the NACK may include a HARQ signal. Additionally, or alternatively, the NACK may be included in DCI. Accordingly, the network node 110 may transmit the NACK using the PDCCH (monitored by the UE 120 during the timer associated with the CG).

As shown by reference number 740, the UE 120 may transmit, and the network node 110 may monitor for (e.g., directly or via the RU 340), a retransmission of the at least one data packet. The UE 120 may retransmit the at least one data packet using a PUSCH. The UE 120 may transmit the at least one data packet according to the CG (e.g., in a following CG occasion).

As shown by reference number 745, the UE 120 may initiate the timer associated with the CG in response to retransmitting the at least one data packet (according to the CG). As shown by reference number 750, the network node 110 may transmit (e.g., directly or via the RU 340), and the UE 120 may receive, an ACK. The network node 110 may transmit the ACK in response to receiving and decoding the at least one data packet. The network node 110 may transmit the ACK before expiry of the timer associated with the CG. In some aspects, the ACK may include a HARQ signal. Additionally, or alternatively, the ACK may be included in DCI. Accordingly, the network node 110 may transmit the ACK using the PDCCH (monitored by the UE 120 during the timer associated with the CG).

Although the example 700 is shown with a single retransmission, other examples may include multiple retransmissions. For example, the network node 110 may fail to receive and decode a first retransmission of the at least one data packet, and thus operations described in connection with reference numbers 735, 740, and 745 may be repeated in order to perform a second retransmission.

As shown by reference number 755, the UE 120 may power off the MR of the UE 120. For example, the UE 120 may power off the MR after receiving the ACK.

As shown by reference number 760, the network node 110 may transmit (e.g., directly or via the RU 340), and the UE 120 may receive (e.g., using the LP-WUR of the UE 120), an LP-WUS. In response to the LP-WUS, the UE 120 may power on the MR of the UE 120, as shown by reference number 765. The network node 110 may refrain from transmitting to the UE 120 after the LP-WUS until the time to power on the MR has passed (e.g., as described in connection with FIG. 5).

As shown by reference number 770, the network node may transmit (e.g., directly or via the RU 340), and the UE 120 may receive (e.g., using the MR), an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 700 is shown with the UE 120 receiving the RRC release message after receiving the LP-WUS, other examples may include the network node 110 transmitting the RRC release message shortly after the ACK (e.g., as described in connection with FIGS. 5 and 6).

By using techniques as described in connection with FIG. 7, the UE 120 conserves power and processing resources outside of the SDT session because the UE 120 may deactivate the MR outside of the SDT session. Additionally, the retransmission is triggered by the timer associated with the CG, which may reduce latency associated with the retransmission.

As indicated above, FIG. 7 is provided as an example. Other examples may differ from what is described with respect to FIG. 7.

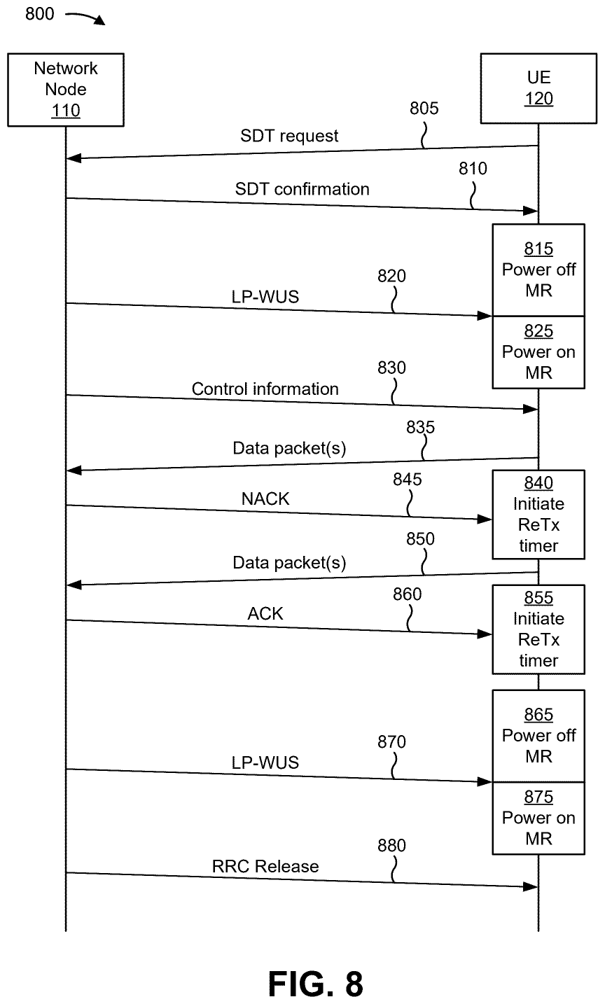

FIG. 8 is a diagram of an example 800 associated with mobile originated retransmissions in an SDT session using a retransmission timer. As shown in FIG. 8, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 805, the UE 120 may transmit, and the network node 110 may receive (e.g., directly or via the RU 340), a request for an SDT session with a network (including the network node 110). The request may be for at least one data packet (e.g., queued for transmission to the network node 110 by the UE 120). The at least one data packet may satisfy a size threshold such that the UE 120 transmits the request for the SDT session based at least in part on the size threshold being satisfied.

In some aspects, the request may be included in an RRC resume request (e.g., an RRCResume message, as defined in 3GPP specifications). In some aspects, the UE 120 may transmit the request using a random access occasion (e.g., for RA-SDT), which may be configured by system information from the network node 110. Alternatively, the UE 120 may transmit the request using a configured grant occasion (e.g., for CG-SDT), which may be configured by an RRC release message from the network node 110 (e.g., an RRCRelease message, as defined in 3GPP specifications).

As shown by reference number 810, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 815, the UE 120 may power off an MR of the UE 120. For example, the UE 120 may power on the MR in order to transmit the request for the SDT session (in a random access occasion or a CG occasion, as described above) and may power off the MR after receiving the confirmation of the SDT session in order to await an LP-WUS from the network node 110. The LP-WUS may initiate the SDT session.

As shown by reference number 820, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 825. The network node 110 may refrain from transmitting to the UE 120 after the LP-WUS until the time to power on the MR has passed (e.g., as described in connection with FIG. 5).

As shown by reference number 830, the network node may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (from the UE 120 to the network node 110). The control information may be received in the SDT session. In some aspects, in response to the control information, the UE 120 may extend an amount of time for which the MR is powered on (e.g., as described in connection with FIG. 5). Alternatively, the UE 120 may power on the MR for a fixed amount of time.

As shown by reference number 835, the UE 120 may transmit, and the network node 110 may monitor for (e.g., directly or via the RU 340), the at least one data packet. The UE 120 may transmit the at least one data packet using a PUSCH. The UE 120 may transmit the at least one data packet based at least in part on the control information. For example, the control information may indicate a set of resources (e.g., in time, frequency, and/or space) for transmitting the at least one data packet.

As shown by reference number 840, the UE 120 may initiate a timer associated with retransmission (e.g., an sdt-ReTxTimerUL, to be defined in 3GPP specifications or another standard) in response to transmitting the at least one data packet. In some aspects, the network node 110 may indicate, to the UE 120, a value for the timer associated with retransmission (e.g., via RRC configuration). The UE 120 may monitor a PDCCH during the timer associated with retransmission (e.g., while the timer is running). The UE 120 may assume that the network node 110 received (and decoded) the at least one data packet when nothing is received on the PDCCH during the timer associated with retransmission.

On the other hand, as shown by reference number 845, the network node 110 may transmit (e.g., directly or via the RU 340), and the UE 120 may receive, a NACK. The network node 110 may transmit the NACK in response to failing to receive or decode the at least one data packet. The network node 110 may transmit the NACK before expiry of the timer associated with retransmission. In some aspects, the NACK may include a HARQ signal. Additionally, or alternatively, the NACK may be included in DCI. Accordingly, the network node 110 may transmit the NACK using the PDCCH (monitored by the UE 120 during the timer associated with retransmission). In some aspects, in response to the NACK, the UE 120 may extend an amount of time for which the MR is powered on.

In some aspects, the network node 110 may transmit the NACK with additional control information. For example, the additional control information may comprise DCI that schedules retransmission of the at least one data packet (from the UE 120 to the network node 110). The additional control information may be received in the SDT session.

As shown by reference number 850, the UE 120 may transmit, and the network node 110 may monitor for (e.g., directly or via the RU 340), a retransmission of the at least one data packet. The UE 120 may retransmit the at least one data packet using a PUSCH. The UE 120 may retransmit the at least one data packet based at least in part on the additional control information. For example, the additional control information may indicate a set of resources (e.g., in time, frequency, and/or space) for retransmitting the at least one data packet.

As shown by reference number 855, the UE 120 may initiate the timer associated with retransmission in response to retransmitting the at least one data packet. As shown by reference number 860, the network node 110 may transmit (e.g., directly or via the RU 340), and the UE 120 may receive, an ACK. The network node 110 may transmit the ACK in response to receiving and decoding the at least one data packet. The network node 110 may transmit the ACK before expiry of the timer associated with retransmission. In some aspects, the ACK may include a HARQ signal. Additionally, or alternatively, the ACK may be included in DCI. Accordingly, the network node 110 may transmit the ACK using the PDCCH (monitored by the UE 120 during the timer associated with retransmission).

Although the example 800 is shown with a single retransmission, other examples may include multiple retransmissions. For example, the network node 110 may fail to receive and decode a first retransmission of the at least one data packet, and thus operations described in connection with reference numbers 845, 850, and 855 may be repeated in order to perform a second retransmission.

As shown by reference number 865, the UE 120 may power off the MR of the UE 120. For example, the UE 120 may power off the MR after receiving the ACK.

As shown by reference number 870, the network node 110 may transmit (e.g., directly or via the RU 340), and the UE 120 may receive (e.g., using the LP-WUR of the UE 120), an LP-WUS. In response to the LP-WUS, the UE 120 may power on the MR of the UE 120, as shown by reference number 875. The network node 110 may refrain from transmitting to the UE 120 after the LP-WUS until the time to power on the MR has passed (e.g., as described in connection with FIG. 5).

As shown by reference number 880, the network node may transmit (e.g., directly or via the RU 340), and the UE 120 may receive (e.g., using the MR), an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 800 is shown with the UE 120 receiving the RRC release message after receiving the LP-WUS, other examples may include the network node 110 transmitting the RRC release message shortly after the ACK (e.g., as described in connection with FIGS. 5 and 6).

By using techniques as described in connection with FIG. 8, the UE 120 conserves power and processing resources outside of the SDT session because the UE 120 may deactivate the MR outside of the SDT session. Additionally, the retransmission is triggered by the timer associated with retransmission, which may reduce latency associated with the retransmission.

As indicated above, FIG. 8 is provided as an example. Other examples may differ from what is described with respect to FIG. 8.

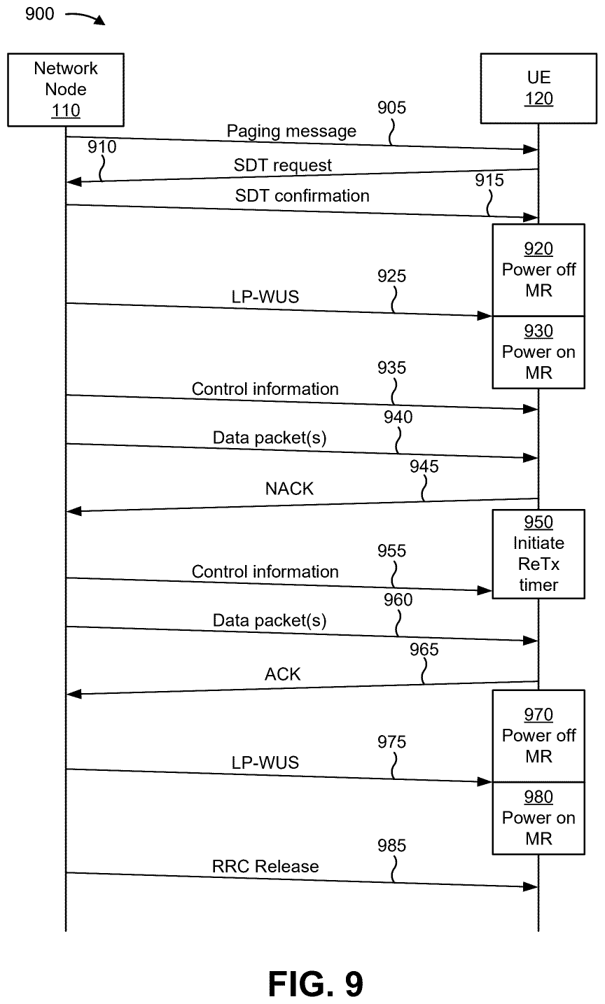

FIG. 9 is a diagram of an example 900 associated with mobile terminated retransmissions in an SDT session using a retransmission timer. As shown in FIG. 9, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 905, the network node 110 may transmit (e.g., directly or via the RU 340), and the UE 120 may receive, a paging message requesting an SDT session with a network. For example, the paging message may include a cause value associated with SDT. The paging message may be for at least one data packet (e.g., queued for transmission to the UE 120 from the network node 110). The at least one data packet may satisfy a size threshold such that the network node 110 transmits the paging message based at least in part on the size threshold being satisfied.

As shown by reference number 910, the UE 120 may transmit, and the network node 110 may receive (e.g., directly or via the RU 340), a request for the SDT session with a network (including the network node 110). The UE 120 may transmit the request in response to the paging message. Additionally, a signal strength measured by the UE 120 (e.g., an RSRP value, among other examples) may satisfy a strength threshold such that the UE 120 may transmit the request based at least in part on the strength threshold being satisfied.

As shown by reference number 915, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 920, the UE 120 may power off an MR of the UE 120. For example, the UE 120 may power on the MR in order to receive the paging message and transmit the request for the SDT session and may power off the MR after receiving the confirmation of the SDT session in order to await an LP-WUS from the network node 110. The LP-WUS may initiate the SDT session.

As shown by reference number 925, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 930. The network node 110 may refrain from transmitting to the UE 120 after the LP-WUS until a time to power on the MR has passed (e.g., as described in connection with FIG. 5).

As shown by reference number 935, the network node 110 may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (to the UE 120 from the network node 110). The control information may be received in the SDT session. In some aspects, in response to the control information, the UE 120 may extend an amount of time for which the MR is powered on (e.g., as described in connection with FIG. 5). Alternatively, the UE 120 may power on the MR for a fixed amount of time.

As shown by reference number 940, the network node 110 may transmit (e.g., directly or via the RU 340), and the UE 120 may monitor for, the at least one data packet. The network node 110 may transmit the at least one data packet using a PDSCH. The network node 110 may transmit the at least one data packet based at least in part on the control information. For example, the control information may indicate a set of resources (e.g., in time, frequency, and/or space) for transmitting the at least one data packet.

As shown by reference number 945, the UE 120 may transmit, and the network node 110 may receive (e.g., directly or via the RU 340), a NACK. The UE 120 may transmit the NACK in response to failing to receive or decode the at least one data packet. In some aspects, the NACK may include a HARQ signal. Additionally, or alternatively, the NACK may be included in UCI. Accordingly, the UE 120 may transmit the NACK using a PUCCH or a PUSCH.

As shown by reference number 950, the UE 120 may initiate a timer associated with retransmission (e.g., an sdt-ReTxTimerUL, to be defined in 3GPP specifications or another standard) in response to transmitting the NACK. In some aspects, the network node 110 may indicate, to the UE 120, a value for the timer associated with retransmission (e.g., via RRC configuration). The UE 120 may monitor a PDCCH during the timer associated with retransmission (e.g., while the timer is running) for additional control information (e.g., to schedule a retransmission of the at least one data packet).

As shown by reference number 955, the network node 110 may transmit (e.g., directly or via the RU 340), and the UE 120 may receive, the additional control information. The network node 110 may transmit the additional control information in response to the NACK. The network node 110 may transmit the additional control information before expiry of the timer associated with retransmission. In some aspects, the network node 110 may transmit the additional control information using the PDCCH (monitored by the UE 120 during the timer associated with retransmission). For example, the additional control information may comprise DCI that schedules retransmission of the at least one data packet (to the UE 120 from the network node 110). The additional control information may be received in the SDT session. In some aspects, in response to the additional control information, the UE 120 may extend an amount of time for which the MR is powered on (e.g., as described in connection with FIG. 5).

As shown by reference number 960, the network node 110 may transmit (e.g., directly or via the RU 340), and the UE 120 may monitor for, a retransmission of the at least one data packet. The network node 110 may retransmit the at least one data packet using a PDSCH. The network node 110 may retransmit the at least one data packet based at least in part on the additional control information. For example, the additional control information may indicate a set of resources (e.g., in time, frequency, and/or space) for retransmitting the at least one data packet.

As shown by reference number 965, the UE 120 may transmit, and the network node 110 may receive (e.g., directly or via the RU 340), an ACK. The UE 120 may transmit the ACK in response to receiving and decoding the at least one data packet. In some aspects, the ACK may include a HARQ signal. Additionally, or alternatively, the ACK may be included in UCI. Accordingly, the UE 120 may transmit the ACK using a PUCCH or a PUSCH.

Although the example 900 is shown with a single retransmission, other examples may include multiple retransmissions. For example, the UE 120 may fail to receive and decode a first retransmission of the at least one data packet, and thus operations described in connection with reference numbers 945, 950, 955, and 960 may be repeated in order to perform a second retransmission.

As shown by reference number 970, the UE 120 may power off the MR of the UE 120. For example, the UE 120 may power off the MR after receiving the ACK.

As shown by reference number 975, the network node 110 may transmit (e.g., directly or via the RU 340), and the UE 120 may receive (e.g., using the LP-WUR of the UE 120), an LP-WUS. In response to the LP-WUS, the UE 120 may power on the MR of the UE 120, as shown by reference number 980. The network node 110 may refrain from transmitting to the UE 120 after the LP-WUS until the time to power on the MR has passed (e.g., as described in connection with FIG. 5).

As shown by reference number 985, the network node may transmit (e.g., directly or via the RU 340), and the UE 120 may receive (e.g., using the MR), an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 900 is shown with the UE 120 receiving the RRC release message after receiving the LP-WUS, other examples may include the network node 110 transmitting the RRC release message shortly after the ACK (e.g., as described in connection with FIGS. 5 and 6).

By using techniques as described in connection with FIG. 9, the UE 120 conserves power and processing resources outside of the SDT session because the UE 120 may deactivate the MR outside of the SDT session. Additionally, the retransmission is triggered by the timer associated with retransmission, which may reduce latency associated with the retransmission.

As indicated above, FIG. 9 is provided as an example. Other examples may differ from what is described with respect to FIG. 9.

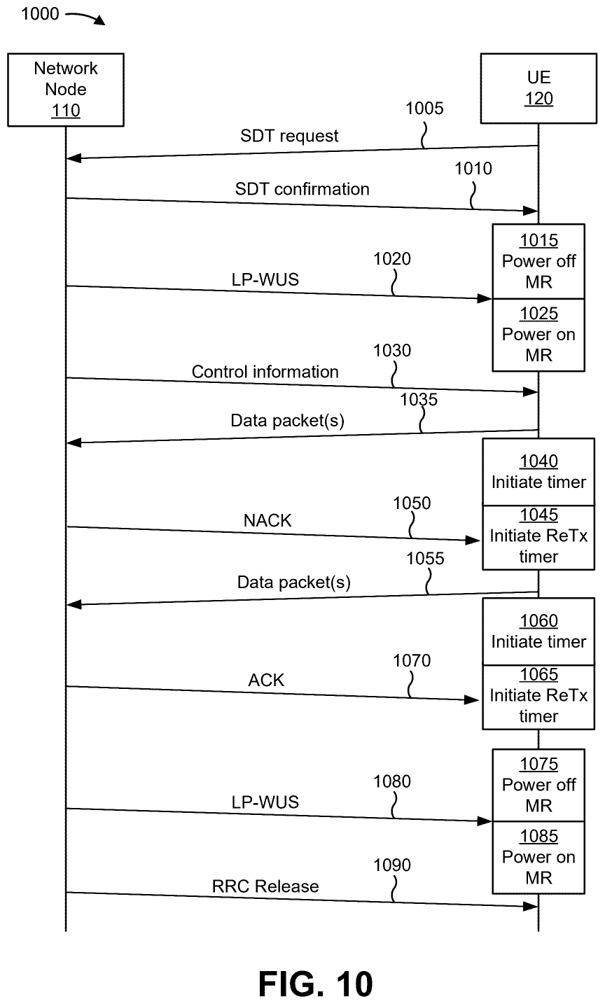

FIG. 10 is a diagram of an example 1000 associated with mobile originated retransmissions in an SDT session using a retransmission timer and a HARQ timer. As shown in FIG. 10, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 1005, the UE 120 may transmit, and the network node 110 may receive (e.g., directly or via the RU 340), a request for an SDT session with a network (including the network node 110). The request may be for at least one data packet (e.g., queued for transmission to the network node 110 by the UE 120). The at least one data packet may satisfy a size threshold such that the UE 120 transmits the request for the SDT session based at least in part on the size threshold being satisfied.

In some aspects, the request may be included in an RRC resume request (e.g., an RRCResume message, as defined in 3GPP specifications). In some aspects, the UE 120 may transmit the request using a random access occasion (e.g., for RA-SDT), which may be configured by system information from the network node 110. Alternatively, the UE 120 may transmit the request using a configured grant occasion (e.g., for CG-SDT), which may be configured by an RRC release message from the network node 110 (e.g., an RRCRelease message, as defined in 3GPP specifications).

As shown by reference number 1010, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 1015, the UE 120 may power off an MR of the UE 120. For example, the UE 120 may power on the MR in order to transmit the request for the SDT session (in a random access occasion or a CG occasion, as described above) and may power off the MR after receiving the confirmation of the SDT session in order to await an LP-WUS from the network node 110. The LP-WUS may initiate the SDT session.

As shown by reference number 1020, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 1025. The network node 110 may refrain from transmitting to the UE 120 after the LP-WUS until the time to power on the MR has passed (e.g., as described in connection with FIG. 5).

As shown by reference number 1030, the network node may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (from the UE 120 to the network node 110). The control information may be received in the SDT session. In some aspects, in response to the control information, the UE 120 may extend an amount of time for which the MR is powered on (e.g., as described in connection with FIG. 5). Alternatively, the UE 120 may power on the MR for a fixed amount of time.

As shown by reference number 1035, the UE 120 may transmit, and the network node 110 may monitor for (e.g., directly or via the RU 340), the at least one data packet. The UE 120 may transmit the at least one data packet using a PUSCH. The UE 120 may transmit the at least one data packet based at least in part on the control information. For example, the control information may indicate a set of resources (e.g., in time, frequency, and/or space) for transmitting the at least one data packet.

As shown by reference number 1040, the UE 120 may initiate a timer associated with a minimum duration before a retransmission grant is expected (e.g., an sdt-HARQ-RTT-TimerUL, to be defined in 3GPP specifications or another standard) in response to transmitting the at least one data packet. For example, the timer may be associated with a minimum duration before a UL HARQ retransmission grant is expected by a MAC entity (of the UE 120). In some aspects, the network node 110 may indicate, to the UE 120, a value for the timer (e.g., via RRC configuration). The network node 110 may refrain from transmitting to the UE 120, and the UE 120 may power off the MR, during the timer (e.g., while the timer is running). As a result, the UE 120 may conserve power and processing resources during the SDT session.

As shown by reference number 1045, the UE 120 may initiate a timer associated with retransmission (e.g., an sdt-ReTxTimerUL, to be defined in 3GPP specifications or another standard) in response to expiry of the timer associated with the minimum duration before a retransmission grant is expected. In some aspects, the network node 110 may indicate, to the UE 120, a value for the timer associated with retransmission (e.g., via RRC configuration). The UE 120 may monitor a PDCCH during the timer associated with retransmission (e.g., while the timer is running). The UE 120 may assume that the network node 110 received (and decoded) the at least one data packet when nothing is received on the PDCCH during the timer associated with retransmission.

On the other hand, as shown by reference number 1050, the network node 110 may transmit (e.g., directly or via the RU 340), and the UE 120 may receive, a NACK. The network node 110 may transmit the NACK in response to failing to receive or decode the at least one data packet. The network node 110 may transmit the NACK before expiry of the timer associated with retransmission. In some aspects, the NACK may include a HARQ signal. Additionally, or alternatively, the NACK may be included in DCI. Accordingly, the network node 110 may transmit the NACK using the PDCCH (monitored by the UE 120 during the timer associated with retransmission). In some aspects, in response to the NACK, the UE 120 may extend an amount of time for which the MR is powered on.

In some aspects, the network node 110 may transmit the NACK with additional control information. For example, the additional control information may comprise DCI that schedules retransmission of the at least one data packet (from the UE 120 to the network node 110). The additional control information may be received in the SDT session.

As shown by reference number 1055, the UE 120 may transmit, and the network node 110 may monitor for (e.g., directly or via the RU 340), a retransmission of the at least one data packet. The UE 120 may retransmit the at least one data packet using a PUSCH. The UE 120 may retransmit the at least one data packet based at least in part on the additional control information. For example, the additional control information may indicate a set of resources (e.g., in time, frequency, and/or space) for retransmitting the at least one data packet.

As shown by reference number 1060, the UE 120 may initiate the timer associated with the minimum duration before a retransmission grant is expected in response to retransmitting the at least one data packet. The network node 110 may refrain from transmitting to the UE 120, and the UE 120 may power off the MR, during the timer (e.g., while the timer is running). As a result, the UE 120 may conserve power and processing resources during the SDT session.

As shown by reference number 1065, the UE 120 may initiate the timer associated with retransmission in response to expiry of the timer associated with the minimum duration before a retransmission grant is expected. As shown by reference number 1070, the network node 110 may transmit (e.g., directly or via the RU 340), and the UE 120 may receive, an ACK. The network node 110 may transmit the ACK in response to receiving and decoding the at least one data packet. The network node 110 may transmit the ACK before expiry of the timer associated with retransmission. In some aspects, the ACK may include a HARQ signal. Additionally, or alternatively, the ACK may be included in DCI. Accordingly, the network node 110 may transmit the ACK using the PDCCH (monitored by the UE 120 during the timer associated with retransmission).

Although the example 1000 is shown with a single retransmission, other examples may include multiple retransmissions. For example, the network node 110 may fail to receive and decode a first retransmission of the at least one data packet, and thus operations described in connection with reference numbers 1050, 1055, 1060, and 1065 may be repeated in order to perform a second retransmission.

As shown by reference number 1075, the UE 120 may power off the MR of the UE 120. For example, the UE 120 may power off the MR after receiving the ACK.

As shown by reference number 1080, the network node 110 may transmit (e.g., directly or via the RU 340), and the UE 120 may receive (e.g., using the LP-WUR of the UE 120), an LP-WUS. In response to the LP-WUS, the UE 120 may power on the MR of the UE 120, as shown by reference number 1085. The network node 110 may refrain from transmitting to the UE 120 after the LP-WUS until the time to power on the MR has passed (e.g., as described in connection with FIG. 5).

As shown by reference number 1090, the network node may transmit (e.g., directly or via the RU 340), and the UE 120 may receive (e.g., using the MR), an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 1000 is shown with the UE 120 receiving the RRC release message after receiving the LP-WUS, other examples may include the network node 110 transmitting the RRC release message shortly after the ACK (e.g., as described in connection with FIGS. 5 and 6).

By using techniques as described in connection with FIG. 10, the UE 120 conserves power and processing resources outside of the SDT session because the UE 120 may deactivate the MR outside of the SDT session. Additionally, the retransmission is triggered by the timer associated with retransmission, which may reduce latency associated with the retransmission. Additionally, the UE 120 may deactivate the MR during the time associated with the minimum duration before a retransmission grant is expected, which conserves power and processing resources during the SDT session.

As indicated above, FIG. 10 is provided as an example. Other examples may differ from what is described with respect to FIG. 10.

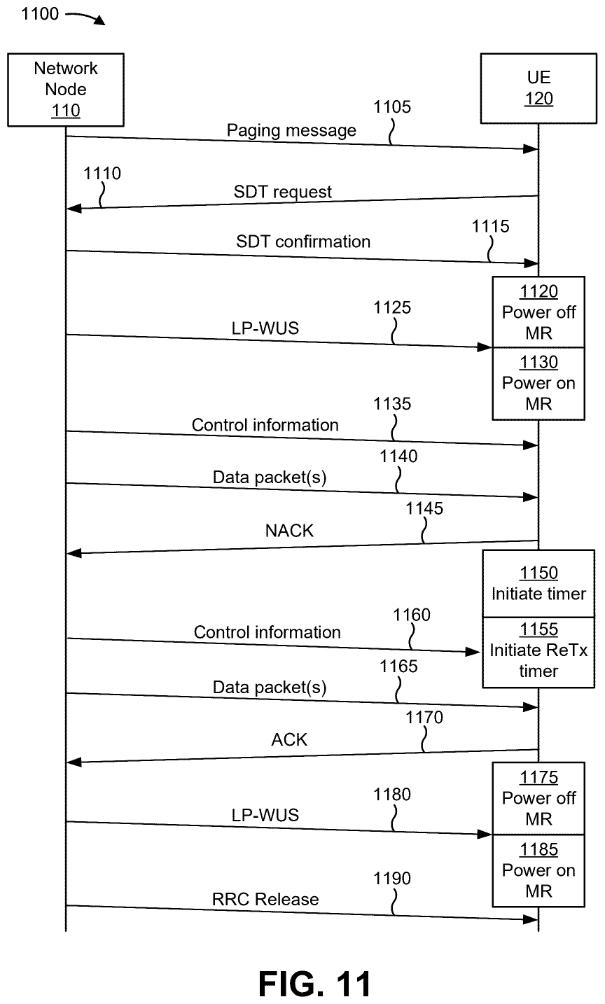

FIG. 11 is a diagram of an example 1100 associated with mobile terminated retransmissions in an SDT session using a retransmission timer and a HARQ timer. As shown in FIG. 11, a network node 110 (e.g., an RU 340 and/or a device controlling the RU 340, such as a DU 330 and/or a CU 310) may communicate with a UE 120. In some aspects, the network node 110 and the UE 120 may communicate OTA within a wireless network (e.g., wireless communication network 100 of FIG. 1).

As shown by reference number 1105, the network node 110 may transmit (e.g., directly or via the RU 340), and the UE 120 may receive, a paging message requesting an SDT session with a network. For example, the paging message may include a cause value associated with SDT. The paging message may be for at least one data packet (e.g., queued for transmission to the UE 120 from the network node 110). The at least one data packet may satisfy a size threshold such that the network node 110 transmits the paging message based at least in part on the size threshold being satisfied.

As shown by reference number 1110, the UE 120 may transmit, and the network node 110 may receive (e.g., directly or via the RU 340), a request for the SDT session with a network (including the network node 110). The UE 120 may transmit the request in response to the paging message. Additionally, a signal strength measured by the UE 120 (e.g., an RSRP value, among other examples) may satisfy a strength threshold such that the UE 120 may transmit the request based at least in part on the strength threshold being satisfied.

As shown by reference number 1115, the network node 110 may transmit (e.g., directly or via the RU 340), and the UE 120 may receive, a confirmation of the SDT session. For example, the confirmation may comprise DCI (e.g., scrambled with a C-RNTI associated with the UE 120).

As shown by reference number 1120, the UE 120 may power off an MR of the UE 120. For example, the UE 120 may power on the MR in order to receive the paging message and transmit the request for the SDT session and may power off the MR after receiving the confirmation of the SDT session in order to await an LP-WUS from the network node 110. The LP-WUS may initiate the SDT session.

As shown by reference number 1125, the network node 110 may transmit (e.g., directly or via the RU 340), and the UE 120 may receive (e.g., using an LP-WUR of the UE 120), the LP-WUS. In response to the LP-WUS, the UE 120 may power on the MR of the UE 120, as shown by reference number 1130. The network node 110 may refrain from transmitting to the UE 120 after the LP-WUS until a time to power on the MR has passed (e.g., as described in connection with FIG. 5).

As shown by reference number 1135, the network node 110 may transmit (e.g., directly or via the RU 340), and the UE 120 may receive (e.g., using the MR), control information. The network node 110 may transmit the control information using a PDCCH. For example, the control information may comprise DCI that schedules transmission of the at least one data packet (to the UE 120 from the network node 110). The control information may be received in the SDT session. In some aspects, in response to the control information, the UE 120 may extend an amount of time for which the MR is powered on (e.g., as described in connection with FIG. 5). Alternatively, the UE 120 may power on the MR for a fixed amount of time.

As shown by reference number 1140, the network node 110 may transmit (e.g., directly or via the RU 340), and the UE 120 may monitor for, the at least one data packet. The network node 110 may transmit the at least one data packet using a PDSCH. The network node 110 may transmit the at least one data packet based at least in part on the control information. For example, the control information may indicate a set of resources (e.g., in time, frequency, and/or space) for transmitting the at least one data packet.

As shown by reference number 1145, the UE 120 may transmit, and the network node 110 may receive (e.g., directly or via the RU 340), a NACK. The UE 120 may transmit the NACK in response to failing to receive or decode the at least one data packet. In some aspects, the NACK may include a HARQ signal. Additionally, or alternatively, the NACK may be included in UCI. Accordingly, the UE 120 may transmit the NACK using a PUCCH or a PUSCH.

As shown by reference number 1150, the UE 120 may initiate a timer associated with a minimum duration before a retransmission grant is expected (e.g., an sdt-HARQ-RTT-TimerUL, to be defined in 3GPP specifications or another standard) in response to transmitting the NACK. For example, the timer may be associated with a minimum duration before a UL HARQ retransmission grant is expected by a MAC entity (of the UE 120). In some aspects, the network node 110 may indicate, to the UE 120, a value for the timer (e.g., via RRC configuration). The network node 110 may refrain from transmitting to the UE, and UE 120 may power off the MR, during the timer (e.g., while the timer is running). As a result, the UE 120 may conserve power and processing resources during the SDT session.

As shown by reference number 1155, the UE 120 may initiate a timer associated with retransmission (e.g., an sdt-ReTxTimerUL, to be defined in 3GPP specifications or another standard) in response to expiry of the timer associated with the minimum duration before a retransmission grant is expected. In some aspects, the network node 110 may indicate, to the UE 120, a value for the timer associated with retransmission (e.g., via RRC configuration). The UE 120 may monitor a PDCCH during the timer associated with retransmission (e.g., while the timer is running) for additional control information (e.g., to schedule a retransmission of the at least one data packet).

As shown by reference number 1160, the network node 110 may transmit (e.g., directly or via the RU 340), and the UE 120 may receive, the additional control information. The network node 110 may transmit the additional control information in response to the NACK. The network node 110 may transmit the additional control information before expiry of the timer associated with retransmission. In some aspects, the network node 110 may transmit the additional control information using the PDCCH (monitored by the UE 120 during the timer associated with retransmission). For example, the additional control information may comprise DCI that schedules retransmission of the at least one data packet (to the UE 120 from the network node 110). The additional control information may be received in the SDT session. In some aspects, in response to the additional control information, the UE 120 may extend an amount of time for which the MR is powered on (e.g., as described in connection with FIG. 5).

As shown by reference number 1165, the network node 110 may transmit (e.g., directly or via the RU 340), and the UE 120 may monitor for, a retransmission of the at least one data packet. The network node 110 may retransmit the at least one data packet using a PDSCH. The network node 110 may retransmit the at least one data packet based at least in part on the additional control information. For example, the additional control information may indicate a set of resources (e.g., in time, frequency, and/or space) for retransmitting the at least one data packet.

As shown by reference number 1170, the UE 120 may transmit, and the network node 110 may receive (e.g., directly or via the RU 340), a ACK. The UE 120 may transmit the ACK in response to receiving and decoding the at least one data packet. In some aspects, the ACK may include a HARQ signal. Additionally, or alternatively, the ACK may be included in UCI. Accordingly, the UE 120 may transmit the ACK using a PUCCH or a PUSCH.

Although the example 1100 is shown with a single retransmission, other examples may include multiple retransmissions. For example, the UE 120 may fail to receive and decode a first retransmission of the at least one data packet, and thus operations described in connection with reference numbers 1145, 1150, 1155, 1160, and 1165 may be repeated in order to perform a second retransmission.

As shown by reference number 1175, the UE 120 may power off the MR of the UE 120. For example, the UE 120 may power off the MR after receiving the ACK.

As shown by reference number 1180, the network node 110 may transmit (e.g., directly or via the RU 340), and the UE 120 may receive (e.g., using the LP-WUR of the UE 120), an LP-WUS. In response to the LP-WUS, the UE 120 may power on the MR of the UE 120, as shown by reference number 1185. The network node 110 may refrain from transmitting to the UE 120 after the LP-WUS until the time to power on the MR has passed (e.g., as described in connection with FIG. 5).

As shown by reference number 1190, the network node may transmit (e.g., directly or via the RU 340), and the UE 120 may receive (e.g., using the MR), an RRC release message (e.g., an RRCRelease message, as defined in 3GPP specifications). The SDT session may be terminated in response to the RRC release message. For example, the UE 120 may power off the MR of the UE 120 in response to the RRC release message. Although the example 1100 is shown with the UE 120 receiving the RRC release message after receiving the LP-WUS, other examples may include the network node 110 transmitting the RRC release message shortly after the ACK (e.g., as described in connection with FIGS. 5 and 6).

By using techniques as described in connection with FIG. 11, the UE 120 conserves power and processing resources outside of the SDT session because the UE 120 may deactivate the MR outside of the SDT session. Additionally, the retransmission is triggered by the timer associated with retransmission, which may reduce latency associated with the retransmission. Additionally, the UE 120 may deactivate the MR during the time associated with the minimum duration before a retransmission grant is expected, which conserves power and processing resources during the SDT session.

As indicated above, FIG. 11 is provided as an example. Other examples may differ from what is described with respect to FIG. 11.

FIG. 12 is a diagram illustrating an example process 1200 performed, for example, at a UE or an apparatus of a UE. Example process 1200 is an example where the apparatus or the UE (e.g., UE 120) performs operations associated with retransmissions in SDT sessions with an LP-WUS.

As shown in FIG. 12, in some aspects, process 1200 may include transmitting, for at least one data packet, a request for an SDT session with a network (block 1210). For example, the UE (e.g., using transmission component 1604 and/or communication manager 1606, depicted in FIG. 16) may transmit, for at least one data packet, a request for an SDT session with a network, as described herein.

As further shown in FIG. 12, in some aspects, process 1200 may include receiving an LP-WUS from the network (block 1220). For example, the UE (e.g., using reception component 1602 and/or communication manager 1606, depicted in FIG. 16) may receive an LP-WUS from the network, as described herein.

As further shown in FIG. 12, in some aspects, process 1200 may include receiving, in the SDT session, control information from the network (block 1230). For example, the UE (e.g., using reception component 1602 and/or communication manager 1606) may receive, in the SDT session, control information from the network, as described herein.

As further shown in FIG. 12, in some aspects, process 1200 may include transmitting, in response to the LP-WUS and in the SDT session, the at least one data packet to the network, based at least in part on the control information (block 1240). For example, the UE (e.g., using transmission component 1604 and/or communication manager 1606) may transmit, in response to the LP-WUS and in the SDT session, the at least one data packet to the network, based at least in part on the control information, as described herein.

Process 1200 may include additional aspects, such as any single aspect or any combination of aspects described below and/or in connection with one or more other processes described elsewhere herein.

In a first aspect, the request is included in an RRC resume message.

In a second aspect, alone or in combination with the first aspect, process 1200 includes receiving (e.g., using reception component 1602 and/or communication manager 1606) a confirmation of the SDT session from the network.

In a third aspect, alone or in combination with one or more of the first and second aspects, process 1200 includes receiving (e.g., using reception component 1602 and/or communication manager 1606) a NACK from the network, and retransmitting (e.g., using transmission component 1604 and/or communication manager 1606), in response to the NACK and in the SDT session, the at least one data packet to the network.

In a fourth aspect, alone or in combination with one or more of the first through third aspects, process 1200 includes receiving (e.g., using reception component 1602 and/or communication manager 1606) an additional LP-WUS in response to the NACK, where the at least one data packet is retransmitted in response to the additional LP-WUS.

In a fifth aspect, alone or in combination with one or more of the first through fourth aspects, process 1200 includes receiving (e.g., using reception component 1602 and/or communication manager 1606), in the SDT session, control information from the network, where the at least one data packet is retransmitted based at least in part on the control information.

In a sixth aspect, alone or in combination with one or more of the first through fifth aspects, process 1200 includes retransmitting (e.g., using transmission component 1604 and/or communication manager 1606) the request for the SDT session with the network based at least in part on expiry of an SDT retransmission timer.

In a seventh aspect, alone or in combination with one or more of the first through sixth aspects, the NACK is received before expiry of a timer associated with a configured grant, and the at least one data packet is retransmitted according to the configured grant.

In an eighth aspect, alone or in combination with one or more of the first through seventh aspects, process 1200 includes initiating (e.g., using communication manager 1606) a timer associated with retransmission in response to transmitting the at least one data packet, where the NACK is received before expiry of the timer associated with retransmission.

In a ninth aspect, alone or in combination with one or more of the first through eighth aspects, process 1200 includes initiating (e.g., using communication manager 1606) a timer, associated with a minimum duration before a retransmission grant is expected, in response to transmitting the at least one data packet.

In a tenth aspect, alone or in combination with one or more of the first through ninth aspects, a main receiver of the UE is powered off during the timer associated with the minimum duration before a retransmission grant is expected.

In an eleventh aspect, alone or in combination with one or more of the first through tenth aspects, process 1200 includes initiating (e.g., using communication manager 1606) a timer associated with retransmission in response to expiry of the timer associated with the minimum duration before a retransmission grant is expected, where the NACK is received before expiry of the timer associated with retransmission.

In a twelfth aspect, alone or in combination with one or more of the first through eleventh aspects, process 1200 includes receiving (e.g., using reception component 1602 and/or communication manager 1606) an ACK from the network, where a main receiver of the UE is powered off in response to the ACK.

In a thirteenth aspect, alone or in combination with one or more of the first through twelfth aspects, process 1200 includes receiving (e.g., using reception component 1602 and/or communication manager 1606) an RRC release message from the network, where the SDT session is terminated in response to the RRC release message.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node. Example process 1300 is an example where the apparatus or the network node (e.g., network node 110) performs operations associated with retransmissions in SDT sessions with an LP-WUS.

As shown in FIG. 13, in some aspects, process 1300 may include receiving a request for an SDT session with a UE (block 1310). For example, the network node (e.g., using reception component 1702 and/or communication manager 1706, depicted in FIG. 17) may receive a request for an SDT session with a UE, as described herein.

As further shown in FIG. 13, in some aspects, process 1300 may include transmitting an LP-WUS to the UE (block 1320). For example, the network node (e.g., using transmission component 1704 and/or communication manager 1706, depicted in FIG. 17) may transmit an LP-WUS to the UE, as described herein.

As further shown in FIG. 13, in some aspects, process 1300 may include transmitting, in the SDT session, control information to the UE (block 1330). For example, the network node (e.g., using transmission component 1704 and/or communication manager 1706) may transmit, in the SDT session, control information to the UE, as described herein.

As further shown in FIG. 13, in some aspects, process 1300 may include monitoring, in the SDT session, for at least one data packet from the UE, based at least in part on the control information (block 1340). For example, the network node (e.g., using reception component 1702 and/or communication manager 1706) may monitor, in the SDT session, for at least one data packet from the UE, based at least in part on the control information, as described herein.

Process 1300 may include additional aspects, such as any single aspect or any combination of aspects described below and/or in connection with one or more other processes described elsewhere herein.

In a first aspect, the request is included in an RRC resume message.

In a second aspect, alone or in combination with the first aspect, process 1300 includes transmitting (e.g., using transmission component 1704 and/or communication manager 1706) a confirmation of the SDT session to the UE.

In a third aspect, alone or in combination with one or more of the first and second aspects, process 1300 includes transmitting (e.g., using transmission component 1704 and/or communication manager 1706) a NACK to the UE in response to failing to receive or decode the at least one data packet, and monitoring (e.g., using reception component 1702 and/or communication manager 1706), in the SDT session, for a retransmission of the at least one data packet from the UE.

In a fourth aspect, alone or in combination with one or more of the first through third aspects, process 1300 includes transmitting (e.g., using transmission component 1704 and/or communication manager 1706) an additional LP-WUS to the UE in response to failing to receive or decode the at least one data packet.

In a fifth aspect, alone or in combination with one or more of the first through fourth aspects, process 1300 includes transmitting (e.g., using transmission component 1704 and/or communication manager 1706), in the SDT session, control information to the UE, where the network node monitors for the retransmission based at least in part on the control information.

In a sixth aspect, alone or in combination with one or more of the first through fifth aspects, the NACK is transmitted before expiry of a timer associated with a configured grant, and the network node monitors for the retransmission according to the configured grant.

In a seventh aspect, alone or in combination with one or more of the first through sixth aspects, the NACK is transmitted before expiry of a timer associated with retransmission.

In an eighth aspect, alone or in combination with one or more of the first through seventh aspects, process 1300 includes refraining from transmitting (e.g., using transmission component 1704 and/or communication manager 1706) to the UE during a timer associated with a minimum duration before a retransmission grant is expected.

In a ninth aspect, alone or in combination with one or more of the first through eighth aspects, the NACK is transmitted before expiry of a timer associated with retransmission, and the timer associated with retransmission is initiated in response to expiry of the timer associated with the minimum duration before a retransmission grant is expected.

In a tenth aspect, alone or in combination with one or more of the first through ninth aspects, process 1300 includes transmitting (e.g., using transmission component 1704 and/or communication manager 1706) an ACK to the UE.

In an eleventh aspect, alone or in combination with one or more of the first through tenth aspects, process 1300 includes transmitting (e.g., using transmission component 1704 and/or communication manager 1706) an RRC release message to the UE, where the SDT session is terminated in response to the RRC release message.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a UE or an apparatus of a UE. Example process 1400 is an example where the apparatus or the UE (e.g., UE 120) performs operations associated with retransmissions in SDT sessions with an LP-WUS.

As shown in FIG. 14, in some aspects, process 1400 may include receiving a paging message requesting an SDT session with a network (block 1410). For example, the UE (e.g., using reception component 1602 and/or communication manager 1606, depicted in FIG. 16) may receive a paging message requesting an SDT session with a network, as described herein.

As further shown in FIG. 14, in some aspects, process 1400 may include receiving an LP-WUS from the network (block 1420). For example, the UE (e.g., using reception component 1602 and/or communication manager 1606) may receive an LP-WUS from the network, as described herein.

As further shown in FIG. 14, in some aspects, process 1400 may include receiving, in the SDT session, control information from the network (block 1430). For example, the UE (e.g., using reception component 1602 and/or communication manager 1606) may receive, in the SDT session, control information from the network, as described herein.

As further shown in FIG. 14, in some aspects, process 1400 may include monitoring, in response to the LP-WUS and in the SDT session, for at least one data packet from the network, based at least in part on the control information (block 1440). For example, the UE (e.g., using reception component 1602 and/or communication manager 1606) may monitor, in response to the LP-WUS and in the SDT session, for at least one data packet from the network, based at least in part on the control information, as described herein.

Process 1400 may include additional aspects, such as any single aspect or any combination of aspects described below and/or in connection with one or more other processes described elsewhere herein.

In a first aspect, the paging message includes a cause value associated with SDT.

In a second aspect, alone or in combination with the first aspect, process 1400 includes transmitting (e.g., using transmission component 1604 and/or communication manager 1606, depicted in FIG. 16) a request for the SDT session in response to the paging message.

In a third aspect, alone or in combination with one or more of the first and second aspects, process 1400 includes receiving (e.g., using reception component 1602 and/or communication manager 1606) a confirmation of the SDT session in response to the request.

In a fourth aspect, alone or in combination with one or more of the first through third aspects, process 1400 includes transmitting (e.g., using transmission component 1604 and/or communication manager 1606) a NACK to the network in response to failing to receive or decode the at least one data packet, and monitoring (e.g., using reception component 1602 and/or communication manager 1606), in the SDT session, for a retransmission of the at least one data packet from the network.

In a fifth aspect, alone or in combination with one or more of the first through fourth aspects, process 1400 includes receiving (e.g., using reception component 1602 and/or communication manager 1606) an additional LP-WUS in response to the NACK, where the UE monitors for the retransmission in response to the additional LP-WUS.

In a sixth aspect, alone or in combination with one or more of the first through fifth aspects, process 1400 includes receiving (e.g., using reception component 1602 and/or communication manager 1606), in the SDT session, control information from the network, where the UE monitors for the retransmission based at least in part on the control information.

In a seventh aspect, alone or in combination with one or more of the first through sixth aspects, process 1400 includes initiating (e.g., using communication manager 1606) a timer associated with retransmission in response to transmitting the NACK, where the UE monitors for control information, associated with the retransmission, during the timer associated with retransmission.

In an eighth aspect, alone or in combination with one or more of the first through seventh aspects, process 1400 includes initiating (e.g., using communication manager 1606) a timer, associated with a minimum duration before a retransmission grant is expected, in response to transmitting the NACK.

In a ninth aspect, alone or in combination with one or more of the first through eighth aspects, a main receiver of the UE is powered off during the timer associated with the minimum duration before a retransmission grant is expected.

In a tenth aspect, alone or in combination with one or more of the first through ninth aspects, process 1400 includes initiating (e.g., using communication manager 1606) a timer associated with retransmission in response to expiry of the timer associated with the minimum duration before a retransmission grant is expected, where the UE monitors for control information, associated with the retransmission, during the timer associated with retransmission.

In an eleventh aspect, alone or in combination with one or more of the first through tenth aspects, process 1400 includes transmitting (e.g., using transmission component 1604 and/or communication manager 1606) an ACK to the network, where a main receiver of the UE is powered off in response to the ACK.

In a twelfth aspect, alone or in combination with one or more of the first through eleventh aspects, process 1400 includes receiving an RRC release message from the network, where the SDT session is terminated in response to the RRC release message.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, at a network node or an apparatus of a network node. Example process 1500 is an example where the apparatus or the network node (e.g., network node 110) performs operations associated with retransmissions in SDT sessions with an LP-WUS.

As shown in FIG. 15, in some aspects, process 1500 may include transmitting, for at least one data packet, a paging message requesting an SDT session with a UE (block 1510). For example, the network node (e.g., using transmission component 1704 and/or communication manager 1706, depicted in FIG. 17) may transmit, for at least one data packet, a paging message requesting an SDT session with a UE, as described herein.

As further shown in FIG. 15, in some aspects, process 1500 may include transmitting an LP-WUS to the UE (block 1520). For example, the network node (e.g., using transmission component 1704 and/or communication manager 1706) may transmit an LP-WUS to the UE, as described herein.

As further shown in FIG. 15, in some aspects, process 1500 may include transmitting, in the SDT session, control information to the UE (block 1530). For example, the network node (e.g., using transmission component 1704 and/or communication manager 1706) may transmit, in the SDT session, control information to the UE, as described herein.

As further shown in FIG. 15, in some aspects, process 1500 may include transmitting, in the SDT session, the at least one data packet to the UE, based at least in part on the control information (block 1540). For example, the network node (e.g., using transmission component 1704 and/or communication manager 1706) may transmit, in the SDT session, the at least one data packet to the UE, based at least in part on the control information, as described herein.

Process 1500 may include additional aspects, such as any single aspect or any combination of aspects described below and/or in connection with one or more other processes described elsewhere herein.

In a first aspect, the paging message includes a cause value associated with SDT.

In a second aspect, alone or in combination with the first aspect, process 1500 includes receiving (e.g., using reception component 1702 and/or communication manager 1706, depicted in FIG. 17) a request for the SDT session in response to the paging message.

In a third aspect, alone or in combination with one or more of the first and second aspects, process 1500 includes transmitting (e.g., using transmission component 1704 and/or communication manager 1706) a confirmation of the SDT session in response to the request.

In a fourth aspect, alone or in combination with one or more of the first through third aspects, process 1500 includes receiving (e.g., using reception component 1702 and/or communication manager 1706) a NACK from the UE, and retransmitting (e.g., using transmission component 1704 and/or communication manager 1706), in response to the NACK and in the SDT session, the at least one data packet to the UE.

In a fifth aspect, alone or in combination with one or more of the first through fourth aspects, process 1500 includes transmitting (e.g., using transmission component 1704 and/or communication manager 1706) an additional LP-WUS in response to the NACK.

In a sixth aspect, alone or in combination with one or more of the first through fifth aspects, process 1500 includes transmitting (e.g., using transmission component 1704 and/or communication manager 1706), in the SDT session, control information to the UE, where the at least one data packet is retransmitted based at least in part on the control information.

In a seventh aspect, alone or in combination with one or more of the first through sixth aspects, process 1500 includes transmitting (e.g., using transmission component 1704 and/or communication manager 1706) control information, associated with retransmission of the at least one data packet, before expiry of a timer associated with retransmission.

In an eighth aspect, alone or in combination with one or more of the first through seventh aspects, process 1500 includes refraining from transmitting (e.g., using transmission component 1704 and/or communication manager 1706) to the UE during a timer associated with a minimum duration before a retransmission grant is expected.

In a ninth aspect, alone or in combination with one or more of the first through eighth aspects, process 1500 includes transmitting (e.g., using transmission component 1704 and/or communication manager 1706) control information, associated with retransmission of the at least one data packet, before expiry of a timer associated with retransmission, where the timer associated with retransmission is initiated in response to expiry of the timer associated with the minimum duration before a retransmission grant is expected.

In a tenth aspect, alone or in combination with one or more of the first through ninth aspects, process 1500 includes receiving (e.g., using reception component 1702 and/or communication manager 1706) an ACK from the UE.

In an eleventh aspect, alone or in combination with one or more of the first through tenth aspects, process 1500 includes transmitting (e.g., using transmission component 1704 and/or communication manager 1706) an RRC release message to the UE, where the SDT session is terminated in response to the RRC release message.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication. The apparatus 1600 may be a UE, or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 5-11. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the UE described in connection with FIG. 1 and FIG. 2. Additionally, or alternatively, one or more components shown in FIG. 16 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

In some aspects, the apparatus 1600 may transmit mobile originated data. For example, the transmission component 1604 may transmit, for at least one data packet, a request for an SDT session with a network. The reception component 1602 may receive an LP-WUS from the network and may receive, in the SDT session, control information from the network. Accordingly, the transmission component 1604 may transmit, in response to the LP-WUS and in the SDT session, the at least one data packet to the network, based at least in part on the control information.

In some aspects, the reception component 1602 may receive a confirmation of the SDT session from the network. In some aspects, the transmission component 1604 may retransmit the request for the SDT session with the network based at least in part on expiry of an SDT retransmission timer.

In some aspects, the reception component 1602 may receive a NACK from the network, and the transmission component 1604 may retransmit, in response to the NACK and in the SDT session, the at least one data packet to the network. In some aspects, the communication manager 1606 may initiate a timer associated with retransmission in response to transmitting the at least one data packet, and the reception component 1602 may receive the NACK before expiry of the timer associated with retransmission. In some aspects, the communication manager 1606 may initiate a timer, associated with a minimum duration before a retransmission grant is expected, in response to transmitting the at least one data packet. Accordingly, the communication manager 1606 may initiate a timer associated with retransmission in response to expiry of the timer associated with the minimum duration before a retransmission grant is expected, and the reception component 1602 may receive the NACK before expiry of the timer associated with retransmission.

In some aspects, the reception component 1602 may receive an additional LP-WUS in response to the NACK, and the transmission component 1604 may retransmit the at least one data packet in response to the additional LP-WUS. Additionally, or alternatively, the reception component 1602 may receive, in the SDT session, control information from the network, and the transmission component 1604 may retransmit the at least one data packet based at least in part on the control information.

In some aspects, the reception component 1602 may receive an ACK from the network, and an MR of the apparatus 1600 may be powered off in response to the ACK. In some aspects, the reception component 1602 may receive an RRC release message from the network, and the SDT session may be terminated in response to the RRC release message.

Additionally, or alternatively, the apparatus 1600 may receive mobile terminated data. For example, the reception component 1602 may receive a paging message requesting an SDT session with a network. The reception component 1602 may further receive an LP-WUS from the network and may receive, in the SDT session, control information from the network. Accordingly, the reception component 1602 may monitor, in response to the LP-WUS and in the SDT session, for at least one data packet from the network, based at least in part on the control information.

In some aspects, the transmission component 1604 may transmit a request for the SDT session in response to the paging message. Additionally, the reception component 1602 may receive a confirmation of the SDT session in response to the request.

In some aspects, the transmission component 1604 may transmit a NACK to the network in response to failing to receive or decode the at least one data packet. Additionally, the reception component 1602 may monitor, in the SDT session, for a retransmission of the at least one data packet from the network. In some aspects, the reception component 1602 may receive an additional LP-WUS in response to the NACK, and the reception component 1602 may monitor for the retransmission in response to the additional LP-WUS.

In some aspects, the communication manager 1606 may initiate a timer associated with retransmission in response to transmitting the NACK, and the reception component 1602 may monitor for control information, associated with the retransmission, during the timer associated with retransmission. In some aspects, the communication manager 1606 may initiate a timer, associated with a minimum duration before a retransmission grant is expected, in response to the transmission component 1604 transmitting the NACK, and the communication manager 1606 may initiate a timer associated with retransmission in response to expiry of the timer associated with the minimum duration before a retransmission grant is expected. Accordingly, the reception component 1602 may monitor for control information, associated with the retransmission, during the timer associated with retransmission. In some aspects, the reception component 1602 may receive, in the SDT session, control information from the network, and the reception component 1602 may monitor for the retransmission based at least in part on the control information.

In some aspects, the reception component 1602 may receive an ACK from the network, and an MR of the apparatus 1600 may be powered off in response to the ACK. In some aspects, the reception component 1602 may receive an RRC release message from the network, and the SDT session may be terminated in response to the RRC release message.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication. The apparatus 1700 may be a network node, or a network node may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 5-11. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the network node described in connection with FIG. 1 and FIG. 2. Additionally, or alternatively, one or more components shown in FIG. 17 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1702 and/or the transmission component 1704 may include or may be included in a network interface. The network interface may be configured to obtain and/or output signals for the apparatus 1700 via one or more communications links, such as a backhaul link, a midhaul link, and/or a fronthaul link.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1704 may be co-located with the reception component 1702 in one or more transceivers.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

In some aspects, the apparatus 1700 may receive mobile originated data. For example, the reception component 1702 may receive a request for a SDT session with a UE. The transmission component 1704 may transmit an LP-WUS to the UE and may transmit, in the SDT session, control information to the UE. Accordingly, the reception component 1702 may monitor, in the SDT session, for at least one data packet from the UE, based at least in part on the control information.

In some aspects, the transmission component 1704 may transmit a confirmation of the SDT session to the UE.

In some aspects, the transmission component 1704 may transmit a negative NACK to the UE in response to failing to receive or decode the at least one data packet. Accordingly, the reception component 1702 may monitor, in the SDT session, for a retransmission of the at least one data packet from the UE.

In some aspects, the transmission component 1704 may transmit an additional LP-WUS to the UE in response to failing to receive or decode the at least one data packet. Additionally, or alternatively, the transmission component 1704 may transmit, in the SDT session, control information to the UE, and the reception component 1702 may monitor for the retransmission based at least in part on the control information. In some aspects, the transmission component 1704 may refrain from transmitting to the UE during a timer associated with a minimum duration before a retransmission grant is expected.

In some aspects, the transmission component 1704 may transmit an ACK to the UE. In some aspects, the transmission component 1704 may transmit an RRC release message to the UE, and the SDT session may be terminated in response to the RRC release message.

In some aspects, the apparatus 1700 may transmit mobile terminated data. For example, the transmission component 1704 may transmit, for at least one data packet, a paging message requesting an SDT session with a UE. The transmission component 1704 may further transmit an LP-WUS to the UE and may transmit, in the SDT session, control information to the UE. Accordingly, the transmission component 1704 may transmit, in the SDT session, the at least one data packet to the UE, based at least in part on the control information.

In some aspects, the reception component 1702 may receive a request for the SDT session in response to the paging message. Accordingly, the transmission component 1704 may transmit a confirmation of the SDT session in response to the request.

In some aspects, the reception component 1702 may receive a NACK from the UE. Accordingly, the transmission component 1704 may retransmit, in response to the NACK and in the SDT session, the at least one data packet to the UE.

In some aspects, the transmission component 1704 may transmit an additional LP-WUS in response to the NACK. Additionally, or alternatively, transmission component 1704 may transmit, in the SDT session, control information to the UE, the transmission component 1704 may retransmit the at least one data packet based at least in part on the control information. In some aspects, the transmission component 1704 may transmit control information, associated with retransmission of the at least one data packet, before expiry of a timer associated with retransmission.

In some aspects, the communication manager 1706 may refrain from transmitting to the UE during a timer associated with a minimum duration before a retransmission grant is expected. Additionally, the transmission component 1704 may transmit control information, associated with retransmission of the at least one data packet, before expiry of a timer associated with retransmission, and the timer associated with retransmission may be initiated in response to expiry of the timer associated with the minimum duration before a retransmission grant is expected.

In some aspects, the transmission component 1704 may transmit an ACK to the UE. In some aspects, the transmission component 1704 may transmit an RRC release message to the UE, and the SDT session may be terminated in response to the RRC release message.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: transmitting, for at least one data packet, a request for a small data transmission (SDT) session with a network; receiving a low-power wake-up signal (LP-WUS) from the network; receiving, in the SDT session, control information from the network; and transmitting, in response to the LP-WUS and in the SDT session, the at least one data packet to the network, wherein the at least one data packet is transmitted based at least in part on the control information.

Aspect 2: The method of Aspect 1, wherein the request is included in a radio resource control resume message.

Aspect 3: The method of any of Aspects 1-2, further comprising: receiving a confirmation of the SDT session from the network.

Aspect 4: The method of any of Aspects 1-3, further comprising:

retransmitting the request for the SDT session with the network based at least in part on expiry of an SDT retransmission timer.

Aspect 5: The method of any of Aspects 1-4, further comprising: receiving a negative acknowledgement (NACK) from the network; and retransmitting, in response to the NACK and in the SDT session, the at least one data packet to the network.

Aspect 6: The method of Aspect 5, further comprising: receiving an additional LP-WUS in response to the NACK, wherein the at least one data packet is retransmitted in response to the additional LP-WUS.

Aspect 7: The method of any of Aspects 5-6, further comprising: receiving, in the SDT session, control information from the network, wherein the at least one data packet is retransmitted based at least in part on the control information.

Aspect 8: The method of any of Aspects 5-7, wherein the NACK is received before expiry of a timer associated with a configured grant, and the at least one data packet is retransmitted according to the configured grant.

Aspect 9: The method of any of Aspects 5-8, further comprising: initiating a timer associated with retransmission in response to transmitting the at least one data packet, wherein the NACK is received before expiry of the timer associated with retransmission.

Aspect 10: The method of any of Aspects 5-9, further comprising: initiating a timer, associated with a minimum duration before a retransmission grant is expected, in response to transmitting the at least one data packet.

Aspect 11: The method of Aspect 10, wherein a main receiver of the UE is powered off during the timer associated with the minimum duration before a retransmission grant is expected.

Aspect 12: The method of any of Aspects 10-11, further comprising: initiating a timer associated with retransmission in response to expiry of the timer associated with the minimum duration before a retransmission grant is expected, wherein the NACK is received before expiry of the timer associated with retransmission.

Aspect 13: The method of any of Aspects 1-12, further comprising: receiving an acknowledgement (ACK) from the network, wherein a main receiver of the UE is powered off in response to the ACK.

Aspect 14: The method of any of Aspects 1-13, further comprising: receiving a radio resource control (RRC) release message from the network, wherein the SDT session is terminated in response to the RRC release message.

Aspect 15: A method of wireless communication performed by a network node, comprising: receiving a request for a small data transmission (SDT) session with a user equipment (UE); transmitting a low-power wake-up signal (LP-WUS) to the UE; transmitting, in the SDT session, control information to the UE; and monitoring, in the SDT session, for at least one data packet from the UE, wherein the network node monitors for the at least one data packet based at least in part on the control information.

Aspect 16: The method of Aspect 15, wherein the request is included in a radio resource control resume message.

Aspect 17: The method of any of Aspects 15-16, further comprising: transmitting a confirmation of the SDT session to the UE.

Aspect 18: The method of any of Aspects 15-17, further comprising:

transmitting a negative acknowledgement (NACK) to the UE in response to failing to receive or decode the at least one data packet; and monitoring, in the SDT session, for a retransmission of the at least one data packet from the UE.

Aspect 19: The method of Aspect 18, further comprising: transmitting an additional LP-WUS to the UE in response to failing to receive or decode the at least one data packet.

Aspect 20: The method of any of Aspects 18-19, further comprising: transmitting, in the SDT session, control information to the UE, wherein the network node monitors for the retransmission based at least in part on the control information.

Aspect 21: The method of any of Aspects 18-20, wherein the NACK is transmitted before expiry of a timer associated with a configured grant, and the network node monitors for the retransmission according to the configured grant.

Aspect 22: The method of any of Aspects 18-21, wherein the NACK is transmitted before expiry of a timer associated with retransmission.

Aspect 23: The method of any of Aspects 18-22, further comprising: refraining from transmitting to the UE during a timer associated with a minimum duration before a retransmission grant is expected.

Aspect 24: The method of Aspect 23, wherein the NACK is transmitted before expiry of a timer associated with retransmission, and the timer associated with retransmission is initiated in response to expiry of the timer associated with the minimum duration before a retransmission grant is expected.

Aspect 25: The method of any of Aspects 15-24, further comprising: transmitting an acknowledgement (ACK) to the UE.

Aspect 26: The method of any of Aspects 15-25, further comprising: transmitting a radio resource control (RRC) release message to the UE, wherein the SDT session is terminated in response to the RRC release message.

Aspect 27: A method of wireless communication performed by a user equipment (UE), comprising: receiving a paging message requesting a small data transmission (SDT) session with a network; receiving a low-power wake-up signal (LP-WUS) from the network; receiving, in the SDT session, control information from the network; and monitoring, in response to the LP-WUS and in the SDT session, for at least one data packet from the network, wherein the UE monitors for the at least one data packet based at least in part on the control information.

Aspect 28: The method of Aspect 27, wherein the paging message includes a cause value associated with SDT.

Aspect 29: The method of any of Aspects 27-28, further comprising: transmitting a request for the SDT session in response to the paging message.

Aspect 30: The method of Aspect 29, further comprising: receiving a confirmation of the SDT session in response to the request.

Aspect 31: The method of any of Aspects 27-30, further comprising: transmitting a negative acknowledgement (NACK) to the network in response to failing to receive or decode the at least one data packet; and monitoring, in the SDT session, for a retransmission of the at least one data packet from the network.

Aspect 32: The method of Aspect 31, further comprising: receiving an additional LP-WUS in response to the NACK, wherein the UE monitors for the retransmission in response to the additional LP-WUS.

Aspect 33: The method of any of Aspects 31-32, further comprising: receiving, in the SDT session, control information from the network, wherein the UE monitors for the retransmission based at least in part on the control information.

Aspect 34: The method of any of Aspects 31-33, further comprising: initiating a timer associated with retransmission in response to transmitting the NACK, wherein the UE monitors for control information, associated with the retransmission, during the timer associated with retransmission.

Aspect 35: The method of any of Aspects 31-34, further comprising: initiating a timer, associated with a minimum duration before a retransmission grant is expected, in response to transmitting the NACK.

Aspect 36: The method of Aspect 35, wherein a main receiver of the UE is powered off during the timer associated with the minimum duration before a retransmission grant is expected.

Aspect 37: The method of any of Aspects 35-36, further comprising: initiating a timer associated with retransmission in response to expiry of the timer associated with the minimum duration before a retransmission grant is expected, wherein the UE monitors for control information, associated with the retransmission, during the timer associated with retransmission.

Aspect 38: The method of any of Aspects 27-37, further comprising:

transmitting an acknowledgement (ACK) to the network, wherein a main receiver of the UE is powered off in response to the ACK.

Aspect 39: The method of any of Aspects 27-38, further comprising: receiving a radio resource control (RRC) release message from the network, wherein the SDT session is terminated in response to the RRC release message.

Aspect 40: A method of wireless communication performed by a network node, comprising: transmitting, for at least one data packet, a paging message requesting a small data transmission (SDT) session with a user equipment (UE); transmitting a low-power wake-up signal (LP-WUS) to the UE; transmitting, in the SDT session, control information to the UE; and transmitting, in the SDT session, the at least one data packet to the UE, wherein the at least one data packet is transmitted based at least in part on the control information.

Aspect 41: The method of Aspect 40, wherein the paging message includes a cause value associated with SDT.

Aspect 42: The method of any of Aspects 40-41, further comprising: receiving a request for the SDT session in response to the paging message.

Aspect 43: The method of Aspect 42, further comprising: transmitting a confirmation of the SDT session in response to the request.

Aspect 44: The method of any of Aspects 40-43, further comprising: receiving a negative acknowledgement (NACK) from the UE; and retransmitting, in response to the NACK and in the SDT session, the at least one data packet to the UE.

Aspect 45: The method of Aspect 44, further comprising: transmitting an additional LP-WUS in response to the NACK.

Aspect 46: The method of any of Aspects 44-45, further comprising: transmitting, in the SDT session, control information to the UE, wherein the at least one data packet is retransmitted based at least in part on the control information.

Aspect 47: The method of any of Aspects 44-46, further comprising: transmitting control information, associated with retransmission of the at least one data packet, before expiry of a timer associated with retransmission.

Aspect 48: The method of any of Aspects 44-47, further comprising: refraining from transmitting to the UE during a timer associated with a minimum duration before a retransmission grant is expected.

Aspect 49: The method of Aspect 48, further comprising: transmitting control information, associated with retransmission of the at least one data packet, before expiry of a timer associated with retransmission, wherein the timer associated with retransmission is initiated in response to expiry of the timer associated with the minimum duration before a retransmission grant is expected.

Aspect 50: The method of any of Aspects 40-49, further comprising: receiving an acknowledgement (ACK) from the UE.

Aspect 51: The method of any of Aspects 40-50, further comprising: transmitting a radio resource control (RRC) release message to the UE, wherein the SDT session is terminated in response to the RRC release message.

Aspect 52: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-51.

Aspect 53: An apparatus for wireless communication at a device, the apparatus comprising one or more memories and one or more processors coupled to the one or more memories, the one or more processors configured to cause the device to perform the method of one or more of Aspects 1-51.

Aspect 54: An apparatus for wireless communication, the apparatus comprising at least one means for performing the method of one or more of Aspects 1-51.

Aspect 55: A non-transitory computer-readable medium storing code for wireless communication, the code comprising instructions executable by one or more processors to perform the method of one or more of Aspects 1-51.

Aspect 56: A non-transitory computer-readable medium storing a set of instructions for wireless communication, the set of instructions comprising one or more instructions that, when executed by one or more processors of a device, cause the device to perform the method of one or more of Aspects 1-51.

Aspect 57: A device for wireless communication, the device comprising a processing system that includes one or more processors and one or more memories coupled with the one or more processors, the processing system configured to cause the device to perform the method of one or more of Aspects 1-51.

Aspect 58: An apparatus for wireless communication at a device, the apparatus comprising one or more memories and one or more processors coupled to the one or more memories, the one or more processors individually or collectively configured to cause the device to perform the method of one or more of Aspects 1-51.

Aspect 59: A device comprising a processing system that includes one or more processors and one or more code-storing memories coupled with the one or more processors, the processing system configured to cause the device to perform the method of one or more of Aspects 1-51.

Aspect 60: A device comprising a processing system that includes processor circuitry and code-storing memory circuitry, the processing system configured to cause the device to perform the method of one or more of Aspects 1-51.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code storing memories coupled with the one or more processors, the processing system configured to cause the UE to:
transmit, for at least one data packet, a request for a small data transmission (SDT) session with a network;
receive a low-power wake-up signal (LP-WUS) from the network;
receive, in the SDT session, control information from the network; and
transmit, in response to the LP-WUS and in the SDT session, the at least one data packet to the network,
wherein the at least one data packet is transmitted based at least in part on the control information.

2. The UE of claim 1, wherein the processing system is configured to cause the UE to:
receive a negative acknowledgement (NACK) from the network; and
retransmit, in response to the NACK and in the SDT session, the at least one data packet to the network.

3. The UE of claim 2, wherein the processing system is configured to cause the UE to:
receive an additional LP-WUS in response to the NACK,
wherein the at least one data packet is retransmitted in response to the additional LP-WUS.

4. The UE of claim 2, wherein the processing system is configured to cause the UE to:
receive, in the SDT session, control information from the network,
wherein the at least one data packet is retransmitted based at least in part on the control information.

5. The UE of claim 2, wherein the NACK is received before expiry of a timer associated with a configured grant, and the at least one data packet is retransmitted according to the configured grant.

6. The UE of claim 2, wherein the processing system is configured to cause the UE to:
initiate a timer associated with retransmission in response to transmitting the at least one data packet,
wherein the NACK is received before expiry of the timer associated with retransmission.

7. The UE of claim 2, wherein the processing system is configured to cause the UE to:
initiate a timer, associated with a minimum duration before a retransmission grant is expected, in response to transmitting the at least one data packet.

8. The UE of claim 7, wherein a main receiver of the UE is powered off during the timer associated with the minimum duration before a retransmission grant is expected.

9. The UE of claim 7, wherein the processing system is configured to cause the UE to:
initiate a timer associated with retransmission in response to expiry of the timer associated with the minimum duration before a retransmission grant is expected,
wherein the NACK is received before expiry of the timer associated with retransmission.

10. A user equipment (UE), comprising:
a processing system that includes one or more processors and one or more code storing memories coupled with the one or more processors, the processing system configured to cause the UE to:
receive a paging message requesting a small data transmission (SDT) session with a network;
receive a low-power wake-up signal (LP-WUS) from the network;
receive, in the SDT session, control information from the network; and
monitor, in response to the LP-WUS and in the SDT session, for at least one data packet from the network,
wherein the UE monitors for the at least one data packet based at least in part on the control information.

11. The UE of claim 10, wherein the processing system is configured to cause the UE to:
transmit a negative acknowledgement (NACK) to the network in response to failing to receive or decode the at least one data packet; and
monitor, in the SDT session, for a retransmission of the at least one data packet from the network.

12. The UE of claim 11, wherein the processing system is configured to cause the UE to:
receive an additional LP-WUS in response to the NACK,
wherein the UE monitors for the retransmission in response to the additional LP-WUS.

13. The UE of claim 11, wherein the processing system is configured to cause the UE to:
receive, in the SDT session, control information from the network,
wherein the UE monitors for the retransmission based at least in part on the control information.

14. The UE of claim 11, wherein the processing system is configured to cause the UE to:
initiate a timer associated with retransmission in response to transmitting the NACK,
wherein the UE monitors for control information, associated with the retransmission, during the timer associated with retransmission.

15. The UE of claim 11, wherein the processing system is configured to cause the UE to:
initiate a timer, associated with a minimum duration before a retransmission grant is expected, in response to transmitting the NACK.

16. The UE of claim 15, wherein a main receiver of the UE is powered off during the timer associated with the minimum duration before a retransmission grant is expected.

17. The UE of claim 15, wherein the processing system is configured to cause the UE to:
initiate a timer associated with retransmission in response to expiry of the timer associated with the minimum duration before a retransmission grant is expected,
wherein the UE monitors for control information, associated with the retransmission, during the timer associated with retransmission.

18. A method of wireless communication performed by a user equipment (UE), comprising:
transmitting, for at least one data packet, a request for a small data transmission (SDT) session with a network;
receiving a low-power wake-up signal (LP-WUS) from the network;
receiving, in the SDT session, control information from the network; and
transmitting, in response to the LP-WUS and in the SDT session, the at least one data packet to the network,
wherein the at least one data packet is transmitted based at least in part on the control information.

19. The method of claim 18, further comprising:
receiving a negative acknowledgement (NACK) from the network; and
retransmitting, in response to the NACK and in the SDT session, the at least one data packet to the network.

20. The method of claim 19, further comprising:
initiating a timer associated with retransmission in response to transmitting the at least one data packet,
wherein the NACK is received before expiry of the timer associated with retransmission.
